(19) United States
(12) Patent Application Publication
(10) Pub. No.: US 2024/0318661 A1
(43) Pub. Date: Sep. 26, 2024

(54) TURBOMACHINE AND METHOD OF ASSEMBLY

(71) Applicant: General Electric Company, Schenectady, NY (US)

(72) Inventors: Jixian Yao, Niskayuna, NY (US); Trevor Howard Wood, Clifton Park, NY (US); Kishore Ramakrishnan, Rexford, NY (US); William Joseph Solomon, Montgomery, OH (US); Giridhar Jothiprasad, Clifton Park, NY (US); Aaron J. King, West Harrison, OH (US)

(21) Appl. No.: 18/678,321

(22) Filed: May 30, 2024

Related U.S. Application Data
(63) Continuation-in-part of application No. 18/654,444, filed on May 3, 2024.
Application No. 18/654,444 is a continuation-in-part of application No. 18/511,128, filed on Nov. 16, 2023.
Application No. 18/511,128 is a continuation of application No. 18/138,442, filed on Apr. 24, 2023, now Pat. No. 11,852,161.
Application No. 18/138,442 is a continuation-in-part of application No. 17/986,544, filed on Nov. 14, 2022, now Pat. No. 11,661,851.

(51) Int. Cl. F04D 29/38; F04D 19/00

(52) U.S. Cl. CPC F04D 29/384; F04D 19/002

(57) ABSTRACT

A gas turbine engine includes an annular casing, a fan disposed inside the annular casing and mounted for rotation about an axial centerline, a core turbine engine drivingly coupled to the fan and comprising a compressor section, a combustion section, and a turbine section arranged in serial flow order, and a variable bleed assembly comprising a variable bleed duct extending between a VB inlet and a VB outlet. The fan includes fan blades that extend radially outwardly toward the annular casing. The fan has an average chord fan width according to a first performance factor. The fan has a quantity of fan blades according to a second performance factor.

### CROSS REFERENCE TO RELATED APPLICATIONS

This application is a continuation-in-part of application U.S. Ser. No. 18/654,444, filed May 3, 2024, which is a continuation-in-part of application U.S. Ser. No. 18/511,128, filed Nov. 16, 2023, which is a continuation of application U.S. Ser. No. 18/138,442, filed on Apr. 24, 2023, now U.S. Pat. No. 11,852,161, which is a continuation-in-part of application U.S. 17/986,544, filed on Nov. 14, 2022, now U.S. Pat. No. 11,661,851, the contents of all of which are incorporated herein by reference in their entireties.

### FIELD

The present disclosure relates generally to jet engines and, more particularly, to jet engine fans.

### BACKGROUND

In one form, a gas turbine engine can include a fan and a core arranged in flow communication with one another. The core generally includes, in serial flow order, a compressor section, a combustion section, a turbine section, and an exhaust section. The fan and the core may be partially surrounded by an outer nacelle. In such approaches, the outer nacelle defines a bypass airflow passage with the core.

In operation, air is provided from the fan to an inlet of the compressor section where one or more axial compressors progressively compress the air until it reaches the combustion section. Fuel is mixed with the compressed air using one or more fuel nozzles within the combustion section and burned to provide combustion gases. The combustion gases are routed from the combustion section to the turbine section. The flow of combustion gases through the turbine section drives the turbine section and is then routed through the exhaust section to atmosphere.

### BRIEF DESCRIPTION OF THE DRAWINGS

A full and enabling disclosure of the present disclosure, including the best mode thereof, directed to one of ordinary skill in the art, is set forth in the specification, with reference to the appended figures, in which:

FIG. 1 is a schematic, cross-sectional view of a gas turbine engine in accordance with exemplary aspects of the present disclosure;

FIG. 2 is a sectional view of a fan blade in accordance with exemplary aspects of the present disclosure;

FIG. 3 shows first example engines arranged on a first plot in accordance with a first performance factor for a fan module according to the present disclosure;

FIG. 4 shows second example engines arranged on a second plot in accordance with a second performance factor for a fan module according to the present disclosure;

FIG. 5 shows third example engines arranged on a third plot in accordance with the first performance factor for a fan module according to the present disclosure;

FIG. 6 shows fourth example engines arranged on a fourth plot in accordance with the second performance factor for a fan module according to the present disclosure;

FIG. 7 is a cross-sectional view of a gas turbine engine in accordance with an exemplary aspect of the present disclosure.

FIG. 8 is a schematic view of a portion of a core turbine engine in accordance with an exemplary embodiment of the present disclosure.

FIG. 9 is a schematic, cross-sectional view of a cooling passage of the core turbine engine of FIG. 6 in accordance with an exemplary embodiment of the present disclosure.

FIG. 10 is a schematic view of a portion of a core turbine engine in accordance with another exemplary embodiment of the present disclosure.

FIG. 11 is a schematic view of a hood of the exemplary core turbine engine of FIG. 8.

FIG. 12 is a schematic view of a hood of a core turbine engine in accordance with an exemplary embodiment of the present disclosure.

FIG. 13 is a schematic view of a portion of a core turbine engine in accordance with another exemplary embodiment of the present disclosure.

FIG. 14 is a schematic view of an ejector in accordance with another exemplary embodiment of the present disclosure.

FIG. 15 is a schematic, cross-sectional view of a cooling passage and variable bleed assembly in accordance with an exemplary embodiment of the present disclosure.

FIG. 16 is a flow diagram of a method of operating a gas turbine engine in accordance with an exemplary aspect of the present disclosure.

FIG. 17 is a cross-sectional view of a gas turbine engine in accordance with another exemplary aspect of the present disclosure.

FIG. 18 is a schematic view of a portion of a core turbine engine in accordance with another exemplary embodiment of the present disclosure.

FIG. 19 is an isometric, cross-sectional view of a variable bleed assembly in accordance with an exemplary embodiment of the present disclosure.

FIG. 20 is a schematic view of a hinged cowl assembly.

FIG. 21 is a schematic view of a portion of a core turbine engine in accordance with another exemplary embodiment of the present disclosure.

Elements in the figures are illustrated for simplicity and clarity and have not necessarily been drawn to scale. For example, the dimensions and/or relative positioning of some of the elements in the figures may be exaggerated relative to other elements to help to improve understanding of variations of the present disclosure. Also, common but well-understood elements that are useful or necessary in a commercially feasible embodiment are often not depicted in order to facilitate a less obstructed view of these variations of the present disclosure. Certain actions and/or steps may be described or depicted in a particular order of occurrence while those skilled in the art will understand that such specificity with respect to sequence is not actually required.

### DETAILED DESCRIPTION

Aspects and advantages of the present disclosure will be set forth in part in the following description or may be learned through practice of the present disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first” and “second” may be used interchangeably to distinguish one component from another and are not intended to signify location or importance of the individual components.

The terms “upstream” and “downstream” refer to the relative direction with respect to a flow in a pathway. For example, with respect to a fluid flow, “upstream” refers to the direction from which the fluid flows, and “downstream” refers to the direction to which the fluid flows.

The terms “radial” or “radially” refer to a direction away from a common center. For example, in the overall context of a turbine engine, radial refers to a direction along a ray extending between a center longitudinal axis of the engine and an outer engine circumference.

The term “composite,” as used herein is, refers to a material that includes non-metallic elements or materials. As used herein, a “composite component” or “composite material” refers to a structure or a component including any suitable composite material. A composite material can be a combination of at least two or more non-metallic elements or materials. Examples of a composite material can be, but not limited to, a polymer matrix composite (PMC), a ceramic matrix composite (CMC), a metal matrix composite (MMC), carbon fibers, a polymeric resin, a thermoplastic resin, bismaleimide (BMI) materials, polyimide materials, an epoxy resin, glass fibers, and silicon matrix materials. Composite components, such as a composite airfoil, can include several layers or plies of composite material. The layers or plies can vary in stiffness, material, and dimension to achieve the desired composite component or composite portion of a component having a predetermined weight, size, stiffness, and strength. One or more layers of adhesive can be used in forming or coupling composite components. Adhesives can include resin and phenolics, wherein the adhesive can require curing at elevated temperatures or other hardening techniques.

As used herein, “PMC” refers to a class of materials. By way of example, the PMC material is defined in part by a prepreg, which is a reinforcement material pre-impregnated with a polymer matrix material, such as thermoplastic resin. Non-limiting examples of processes for producing thermoplastic prepregs include hot melt pre-pregging in which the fiber reinforcement material is drawn through a molten bath of resin and powder pre-pregging in which a resin is deposited onto the fiber reinforcement material, by way of non-limiting example electrostatically, and then adhered to the fiber, by way of non-limiting example, in an oven or with the assistance of heated rollers. The prepregs can be in the form of unidirectional tapes or woven fabrics, which are then stacked on top of one another to create the number of stacked plies desired for the part. Multiple layers of prepreg may be stacked to the proper thickness and orientation for the composite component and then the resin is cured and solidified to render a fiber reinforced composite part. Resins for matrix materials of PMCs can be generally classified as thermosets or thermoplastics. Thermoplastic resins are generally categorized as polymers that can be repeatedly softened and flowed when heated and hardened when sufficiently cooled due to physical rather than chemical changes. Notable example classes of thermoplastic resins include nylons, thermoplastic polyesters, polyaryletherketones, and polycarbonate resins. Specific example of high performance thermoplastic resins that have been contemplated for use in aerospace applications include, polyetheretherketone (PEEK), polyetherketoneketone (PEKK), polyetherimide (PEI), polyaryletherketone (PAEK), and polyphenylene sulfide (PPS). In contrast, once fully cured into a hard rigid solid, thermoset resins do not undergo significant softening when heated, but instead thermally decompose when sufficiently heated. Notable examples of thermoset resins include epoxy, bismaleimide (BMI), and polyimide resins.

Instead of using a prepreg, in another non-limiting example, with the use of thermoplastic polymers, it is possible to utilize a woven fabric. Woven fabric can include, but is not limited to, dry carbon fibers woven together with thermoplastic polymer fibers or filaments. Non-prepreg braided architectures can be made in a similar fashion. With this approach, it is possible to tailor the fiber volume of the part by dictating the relative concentrations of the thermoplastic fibers and reinforcement fibers that have been woven or braided together. Additionally, different types of reinforcement fibers can be braided or woven together in various concentrations to tailor the properties of the part. For example, glass fibers, carbon fibers, and thermoplastic fibers could all be woven together in various concentrations to tailor the properties of the part. The carbon fibers provide the strength of the system, the glass fibers can be incorporated to enhance the impact properties, which is a design characteristic for parts located near the inlet of the engine, and the thermoplastic fibers provide the binding for the reinforcement fibers.

In yet another non-limiting example, resin transfer molding (RTM) can be used to form at least a portion of a composite component. Generally, RTM includes the application of dry fibers or matrix material to a mold or cavity. The dry fibers or matrix material can include prepreg, braided material, woven material, or any combination thereof.

Resin can be pumped into or otherwise provided to the mold or cavity to impregnate the dry fibers or matrix material. The combination of the impregnated fibers or matrix material and the resin are then cured and removed from the mold. When removed from the mold, the composite component can require post-curing processing.

It is contemplated that RTM can be a vacuum assisted process. That is, the air from the cavity or mold can be removed and replaced by the resin prior to heating or curing. It is further contemplated that the placement of the dry fibers or matrix material can be manual or automated.

The dry fibers or matrix material can be contoured to shape the composite component or direct the resin. Optionally, additional layers or reinforcing layers of material differing from the dry fiber or matrix material can also be included or added prior to heating or curing.

The singular forms “a,” “an,” and “the” include plural references unless the context clearly dictates otherwise.

The inventors have sought to maximize efficiency of turbine engines during in-flight propulsion of an aircraft, and correspondingly reduce fuel consumption. In particular, the inventors were focused on how the fan of a ducted turbine engine can be improved. The inventors, in consideration of several different engine architectures proposed, considered how the fan module would need to change to achieve mission requirements, and/or how the fan module could improve upon an existing engine efficiency and/or fuel consumption. The inventors looked at several engine architectures, then determined how the number of fan blades utilized with a fan, average chord width of the fan blades, diameter of the fan blade, fan pressure ratio, fan tip speed, and hub-to-tip ratio affect engine efficiency and/or fuel consumption.

The inventors found that in some engines, an excess number of fan blades may add unnecessary cost to the engine design without appreciable benefit, and may also add unnecessary weight to an aircraft, thereby reducing overall fuel efficiency (e.g., due to increased fuel burn). A reduction in fan blade quantity, however, was found to potentially lead to a reduction in total fan blade area desired for efficient propulsion, fan aeromechanical stability and operability, etc. The inventors considered increasing the width or fan chord of the fan blades to achieve a desired fan blade area with a lower fan blade count. Such considerations were found to be of particular interest when the engine had a higher bypass ratio (i.e., lower fan pressure ratio), and when the engine had a lower blade tip speed.

The determination of the fan blade count and average fan chord for achieving a desired efficiency often required a time consuming, iterative process. As explained in greater detail below, after evaluation of numerous turbine engine architectures having different fan blade counts and average fan chords, it was found, unexpectedly, that there exist certain relationships between a fan or fan blade diameter, a fan pressure ratio, and a redline corrected fan tip Mach number of the turbine engine that identify an average fan chord needed to produce improved results in terms of engine efficiency. It was further found, unexpectedly, that there exist certain relationships between turbine engine parameters including a hub-to-tip ratio of the fan, a fan pressure ratio, and a redline corrected fan tip Mach number of the turbine engine that identify a fan blade count needed to produce improved results in terms of engine efficiency.

Various aspects of the present disclosure describe aspects of an aircraft turbine engine characterized in part by an increased average fan chord width and a reduced blade count, which are believed to result in an improved engine aerodynamic efficiency and/or improved fuel efficiency. According to the disclosure, a turbomachine for powering an aircraft in flight comprises an annular casing and a fan disposed inside the annular casing and mounted for rotation about an axial centerline, the fan including fan blades that extend radially outwardly toward the annular casing.

Reference will now be made in detail to embodiments of the disclosure, one or more examples of which are illustrated in the accompanying drawings, which are incorporated in and constitute a part of this specification, illustrate embodiments of the disclosure and, together with the description, serve to explain the principles of the disclosure. The detailed description uses numerical and letter designations to refer to features in the drawings. Like or similar designations in the drawings and description have been used to refer to like or similar parts of the disclosure.

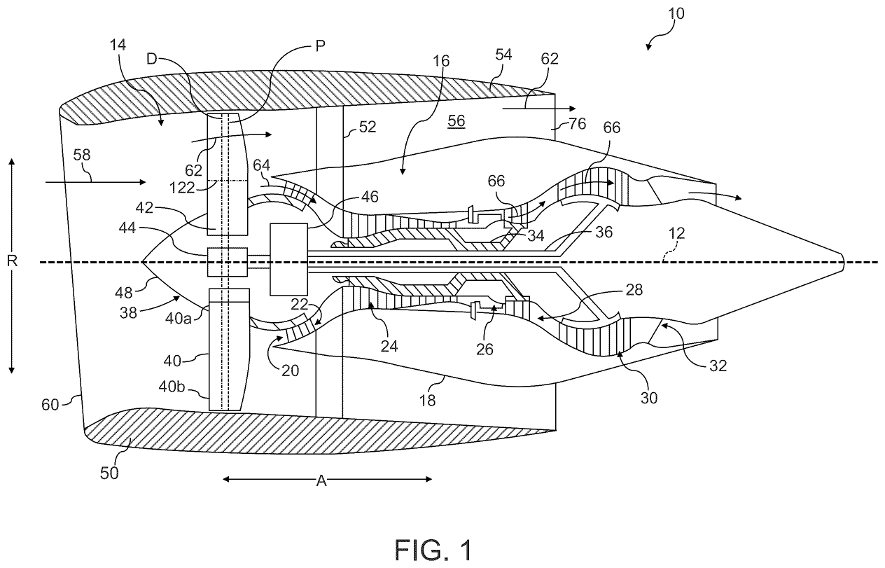

Referring now to the drawings, FIG. 1 is a schematic, cross-sectional view of a gas turbine engine 10, in accordance with an exemplary embodiment of the present disclosure. More particularly, for the embodiment of FIG. 1, the gas turbine engine 10 is a high-bypass turbofan jet engine, gas turbine engine 10As shown in FIG. 1, the gas turbine engine 10 defines an axial direction A (extending parallel to a longitudinal centerline 12 provided for reference) and a radial direction R. In general, the gas turbine engine 10 includes a fan section 14 and a core turbine engine 16 disposed downstream from the fan section 14.

The exemplary core turbine engine 16 depicted generally includes a substantially tubular outer casing 18 that defines an annular inlet 20. The tubular outer casing 18 encases, in serial flow relationship, a compressor section including a booster, such as a low pressure (LP) compressor 22, and a high pressure (HP) compressor 24; a combustion section 26; a turbine section including a high pressure (HP) turbine 28 and a low pressure (LP) turbine 30; and an exhaust nozzle 32. A high pressure (HP) shaft or spool 34 drivingly connects the HP turbine 28 to the HP compressor 24. A low pressure (LP) shaft or spool 36 drivingly connects the LP turbine 30 to the LP compressor 22.

Fan blades 40 extend outwardly from disk 42 generally along the radial direction R. For the embodiment depicted, the fan section 14 includes a variable pitch fan 38 having a plurality of fan blades 40 coupled to a disk 42 in a spaced apart manner. One or more of the fan blades 40 may rotatable relative to the disk 42 about a pitch axis P by virtue of the fan blades 40 being operatively coupled to an actuator 44 configured to vary the pitch of the fan blades 40, typically collectively in unison. In some approaches, the fan is a fixed pitch fan and the actuator 44 is not present. The fan blades 40, disk 42, and the actuator 44 may be together rotatable about the longitudinal centerline 12 by LP spool 36 across a power gear box 46. The power gear box 46 includes a plurality of gears for stepping down the rotational speed of the LP spool 36 to a more efficient rotational fan speed. In some approaches, the LP spool 36 may directly drive the fan without power gear box 46.

The power gear box 46 can include a plurality of gears, including an input and an output, and may also include one or more intermediate gears disposed between and/or interconnecting the input and the output. The input can comprise a first rotational speed and the output can have a second rotational speed. In some examples, a gear ratio of the first rotational speed to the second rotational speed is equal to or greater than 3.2 and equal to or less than 5.0. The power gear box 46 can comprise various types and/or configurations. In some examples, the power gear box 46 is a single-stage gear box. In other examples, the power gear box 46 is a multi-stage gear box. In some examples, the power gear box 46 is an epicyclic gearbox. In some examples, the power gear box 46 is a non-epicyclic gear box (e.g., a compound gearbox). More particularly, in some instances, the power gear box 46 is an epicyclic gear box configured in a star gear configuration. Star gear configurations comprise a sun gear, a plurality of star gears (which can also be referred to as “planet gears”), and a ring gear. The sun gear is the input and is coupled to the power turbine (e.g., the low-pressure turbine) such that the sun gear and the power turbine rotate at the same rotational speed. The star gears are disposed between and interconnect the sun gear and the ring gear. The star gears are rotatably coupled to a fixed carrier. As such, the star gears can rotate about their respective axes but cannot collectively orbit relative to the sun gear or the ring gear. As another example, the power gear box 46 is an epicyclic gear box configured in a planet gear configuration. Planet gear configurations comprise a sun gear, a plurality of planet gears, and a ring gear. The sun gear is the input and is coupled to the power turbine. The planet gears are disposed between and interconnect the sun gear and the ring gear. The planet gears are rotatably coupled to a rotatable carrier. As such, the planet gears can rotate about their respective axes and also collectively rotate together with the carrier relative to the sun gear and the ring gear. The carrier is the output and is coupled to the fan assembly. The ring gear is fixed from rotation.

Referring still to the exemplary embodiment of FIG. 1, the disk 42 is covered by rotatable front hub 48 aerodynamically contoured to promote an airflow through the plurality of fan blades 40. Additionally, the exemplary fan section 14 includes an annular fan casing or outer nacelle 50 that circumferentially surrounds the variable pitch fan 38 and/or at least a portion of the core turbine engine 16. It should be appreciated that the outer nacelle 50 may be configured to be supported relative to the core turbine engine 16 by a plurality of circumferentially spaced outlet guide vanes 52. Moreover, a downstream section 54 of the outer nacelle 50 may extend over an outer portion of the core turbine engine 16 so as to define a bypass airflow passage 56 therebetween.

During operation of the gas turbine engine 10, a volume of air 58 enters the gas turbine engine 10 through an associated inlet 60 of the outer nacelle 50 and/or fan section 14. As the volume of air 58 passes across the fan blades 40, a first portion 62 of the air 58, as indicated by arrow 62, is directed or routed into the bypass airflow passage 56 and a second portion 64 of the air 58, as indicated by arrow 64, is directed or routed into the LP compressor 22. The ratio between the first portion 62 of air 58 and the second portion 64 of air 58 is commonly known as a bypass ratio. The pressure of the second portion 64 of air 58 is then increased as it is routed through the HP compressor 24 and into the combustion section 26, where it is mixed with fuel and burned to provide combustion gases 66. Subsequently, the combustion gases 66 are routed through the HP turbine 28 and the LP turbine 30, where a portion of thermal and/or kinetic energy from the combustion gases 66 is extracted.

The combustion gases 66 are then routed through the exhaust nozzle 32 of the core turbine engine 16 to provide propulsive thrust. Simultaneously, the pressure of the first portion 62 of air 58 is substantially increased as the first portion 62 of air 58 is routed through the bypass airflow passage 56 before it is exhausted from a fan nozzle exhaust section 76 of the gas turbine engine 10, also providing propulsive thrust.

It should be appreciated, however, that the gas turbine engine 10 depicted in FIG. 1 is by way of example only, and that in other exemplary embodiments, aspects of the present disclosure may additionally, or alternatively, be applied to any other suitable gas turbine engine. For example, in other exemplary embodiments, the gas turbine engine 10 may instead be any other suitable aeronautical gas turbine engine, such as a turbojet engine, turboshaft engine, turboprop engine, etc. Additionally, in still other exemplary embodiments, the gas turbine engine 10 may include or be operably connected to any other suitable accessory systems. Additionally, or alternatively, the exemplary gas turbine engine 10 may not include or be operably connected to one or more of the accessory systems discussed above.

The fan blades 40 of the gas turbine engine 10 may be made from a PMC material with metal leading edges to protect the airfoil from foreign objects, such as bird strikes. A polymer matrix composite (PMC) material for the airfoil can be more durable and/or exhibit improved performance when the airfoil is subjected to flutter effects during operation. In some embodiments, engines with fewer fan blades (e.g., less than 25 fan blades) and wider chords (c), such as engines having a blade count (BC) from 14 and 18, or 16 to 20 fan blades and ratios of chord to diameter (c/D) of greater than 0.17, or greater than 0.19, and less than 0.3 (e.g., less than 0.21) have the fan blade airfoil made from a PMC material with metal leading edge.

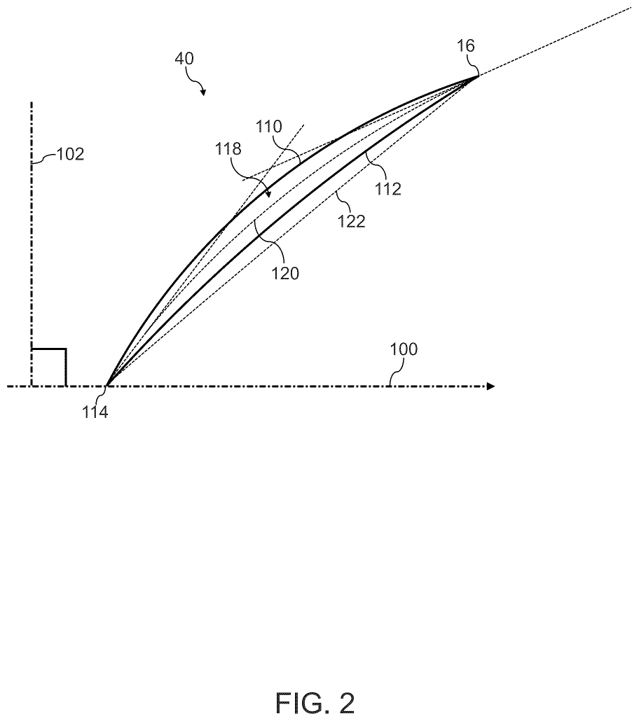

FIG. 2 is a sectional view of a fan blade 40 viewed radially (e.g., towards the rotation axis). A first axis 100 is parallel to the axial direction A of FIG. 1, and a second axis 102 is parallel to the circumferential direction θ.

Fan blade 40 includes a low-pressure surface 110 and an opposite high-pressure surface 112 that each extend between a proximal end 40a and a distal end 40b of the fan blade 40 (shown in FIG. 1). Fan blade 40 further includes a leading edge 114 and a trailing edge 116.

The low-pressure surface 110, high-pressure surface 112, leading edge 114, and trailing edge 116 form a profile 118 of the fan blade 40. The profile 118 defines a mean camber 120 that extends from the leading edge 114 to the trailing edge 116 and that is equidistant from the low-pressure surface 110 and the high-pressure surface 112.

The profile 118 further defines a local chord 122 (relative to a specific cross section through the blade) that represents a straight-line distance from the leading edge 114 to the trailing edge 116.

In some approaches, a fan blade 40 may have a profile 118 that varies along a radial height of the fan blade 40 between the proximal end 40a and the distal end 40b. For example, in some fan blade designs, a distance between the leading edge 114 and the trailing edge 116 may be greater at the proximal end 40a of the fan blade 40 than at the distal end 40b. As such, the length of the local chord 122 may vary along the radial height of the fan blade 40. In this way, an average chord line length may be derived for the fan blade that accounts for the variation in lengths of the local chord 122 along the radial height of the fan blade 40.

As mentioned earlier, the inventors have discovered relationships between timescales that include a fan pressure ratio, fan diameter, and corrected fan tip Mach number during the course of improving upon the fan module portion of various engine architectures. More particularly, and as discussed in greater detail below, the inventors have discovered relationships between ratio of axial flow timescales to rotation timescales, and suitable parameters for implementing those relationships with an engine.

The aircraft turbine engine architectures developed by the inventors include as major components a fan module and an engine core. The core includes one or more compressor stages and turbine stages. Compressor stages typically include high pressure and low pressure compressor stages, and turbines similarly include high and low pressure stages. The fan module that provides for an improved efficiency is not independent of these other parts of the engine, because there is always a trade benefit when one part is improved or modified. Improved efficiency brought by the fan can be in terms of a reduction in weight, lower installed drag, load balancing or management (dynamic or static loading), aerodynamic efficiency through the fan duct/interaction of fan to output guide vanes, and other factors. In an effort to improve upon what the fan can deliver (positive benefit of fan design) there often times need to be sacrifices in other parts of the engine (negative benefit of fan design). Or the benefits of a new fan design when viewed independent of a particular core design or airframe requirement, often times requires revision or is unrealistic given the impact that such a fan design will have on other parts of the engine, e.g., compressor operating margin, balance of a fan and output guide vanes (OGV) along with a power gearbox, and location of a low pressure compressor (packaging impacts). The teachings described herein are also applicable to other engine architectures such as electrically-driven fans (which may or may not include a turbine) and hybrid electrically-driven fans (e.g., distributed electric propulsion systems in which a gas turbine drives multiple fans).

The inventors, proceeding in the manner of designing improved fan modules, accounting for the trade-offs between fan module improvements and other potentially negative or limitations on fan module design, unexpectedly found certain relationships that define an improved fan design, now described in detail.

In one aspect, the inventors have discovered a relationship between an average fan chord “c”, a fan diameter “D” (e.g., a tip-to-tip dimension of the fan), a fan pressure ratio “FPR” of a fan, and a corrected redline fan tip Mach number “M_{tip,c}^{(RL)}” according to the below relationship, referred to herein as the First Performance Factor (“FPF”) for a fan module:

$$FPF = [ \frac{c}{0.15 \cdot D} ] / [ [ \frac{\sqrt{FPR - 1}}{\sqrt{0.4}} ] / {M}_{tip , c}^{( RL )} ] - 1.23 \qquad ( 1 )$$

$${m}_{1} \cdot [ {M}_{tip , c}^{( RL )} - 1.1 ] + 6 > FPF > {m}_{1} \cdot [ {M}_{tip , c}^{( RL )} - 1.1 ] + Δ {y}_{1} \qquad ( 2 )$$

The ratio of average fan chord “c” to fan diameter “D” is a nondimensionalized chord width ratio greater than 0.1 (e.g., greater than 0.15, greater than 0.17, or greater than 0.19), and less than 0.3 (e.g., less than 0.21).

As used herein, the “fan pressure ratio” (FPR) refers to a ratio of a stagnation pressure immediately downstream of the plurality of outlet guide vanes 52 during operation of the fan 38 to a stagnation pressure immediately upstream of the plurality of fan blades 40 during the operation of the fan 38. The “\sqrt{FPR−1}” portion of the average fan chord relationship may be utilized as a surrogate for referencing a proportionality to the increase in axial flow velocity through the fan. The fan pressure ratio is greater than 1.2 (e.g., greater than 1.3), and less than 1.5 (e.g., less than 1.45, less than 1.42, or less than 1.4).

As used herein, “M_{tip,c}^{(RL)}” is a corrected fan tip Mach number at redline (e.g., maximum permissible rotational speed of the fan at a redline shaft speed, which is either directly coupled to the fan or through a reduction gearbox). “Fan tip speed” refers to a linear speed of an outer tip of a fan blade 40 during operation of the fan 38. “Corrected fan tip speed” (referred to as “U_{tip,c}”) may be provided, for example, as ft/sec divided by an industry standard temperature correction. In an example approach, U_{tip,c} may be less than 1,500 ft/sec (e.g., less than 1,250 ft/sec or less than 1,100 ft/sec), and greater than 500 ft/sec. “Corrected fan tip Mach number” refers to a nondimensionalized value obtained by dividing U_{tip,c} by the generally accepted speed of sound at standard day sea level atmospheric conditions (i.e., 1,116.45 ft/sec). As such, M_{tip,c}^{(RL)} may be less than 1.34 (e.g., less than 1.12 or less than 0.99), and greater than 0.45.

FPF, as defined in (1), may be thought of as representing a ratio of speeds. When considered with the normalized chord width “c/D,” FPF may be thought of as a correlation of timescales of the blade rotation with the time taken for a flow particle to traverse a fan average chord length when the engine is operating at static conditions.

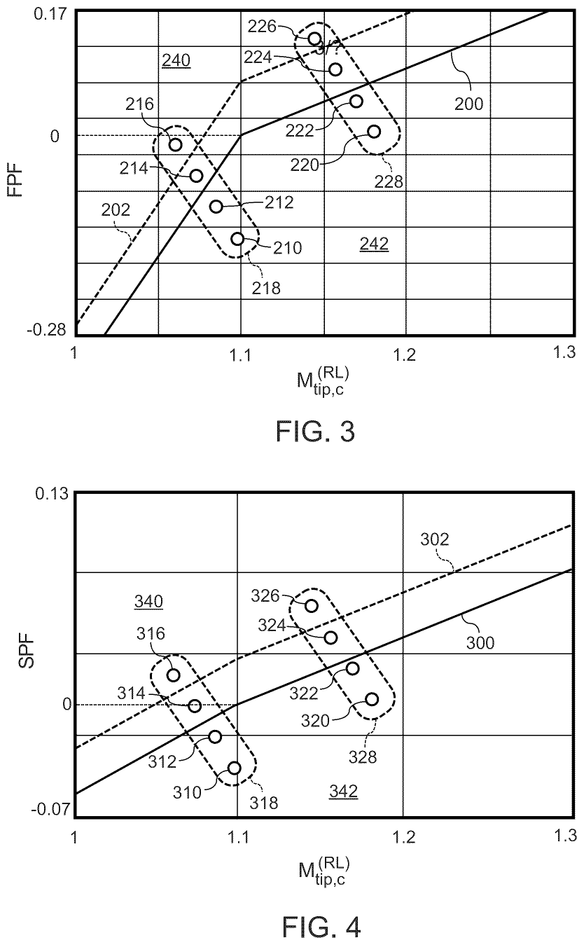

Referring to the inequality defined in (2) and to the plot of FIG. 3, example engine embodiments are shown having unique FPF values and corresponding redline corrected fan tip Mach number (M_{tip,c}^{(RL)}). FPF increases in value along the Y-axis, while the X-axis represents left-to-right increasing redline corrected fan tip Mach number (M_{tip,c}^{(RL)}). FIG. 3 also shows a first line 200 and a second line 202 that is offset from the first line 200 along the Y-axis. The first and second lines 200, 202 are defined by the “m₁·[M_{tip,c}^{(RL)-}1.1]+Δy₁” portion of inequality (2). As used herein, “m₁” refers to a slope of a line 200, 202, “1.1” refers to a reference corrected redline tip Mach number at which Y-intercept is defined in the FPF, and Δy₁ refers an offset from the Y-intercept along the Y-axis.

As shown in FIG. 3, the first and second lines 200, 202 are piecewise linear dividing curves; i.e., the first and second lines 200, 202 have different slopes “m₁” depending on the M_{tip,c}^{(RL)} along the X-axis. More particularly, when the value of M_{tip,c}^{(RL)} is equal to or greater than 1.1, the first and second lines 200, 202 have slopes “m₁” equal to 0.87. When the value of M_{tip,c}^{(RL)} is less than 1.1, the first and second lines 200, 202 have slopes “m” equal to 3.34. While depicted as piecewise linear dividing curves, the low-speed scaling is actually nonlinear and there are advantages to lower c/D designs toward the lower portion of the plot of FIG. 3 associated with lower FPR and lower M_{tip,c}^{(RL)}.

As discussed, Δy₁ refers an offset from the Y-intercept along the Y-axis. The Δy₁ value can be 0.0125, 0.04, 0.07, 0.1, or 0.2, or can vary between 0 and 6, 0 and 0.0125, 0.0125 and 0.04, 0.04 and 0.07, 0.07 and 0.1, 0.1 and 0.2, or a value greater than 0.2 and less than 6.

FIG. 3 shows eight example engine embodiments, of which gas turbine engines 210, 212, 214, 216 may be referred to as low speed engine designs (as indicated by subplot area 218), and engines 220, 222, 224, 226 may be referred to as high speed engine designs (as indicated by subplot area 228). Each of the gas turbine engines 210, 212, 214, 216, 220, 222, 224, 226 have a gear ratio in a range equal to or greater than 3.2 and less than or equal to 5.0.

As represented by the FPF, which indicates a particular fan chord relationship, the inventors discovered a limited or narrowed selection of average fan chords that uniquely take into consideration other factors associated with the fan and engine type. For instance, the inventors determined that an engine having an FPF value for a given M_{tip,c}^{(RL)} value above line 200 (within plot area 240) may allow for relatively wider chord widths as compared to engines having an FPF value for a given M_{tip,c}^{(RL)} value below line 200 (within plot area 242). In this way, gas turbine engines 214, 216, 224, and 226 may provide advantages over gas turbine engines 210, 212, 220, and 222, such as a reduced fan blade count (discussed in greater detail below), increased aeromechanical stability and reduced fan lift coefficient C_{L} during takeoff of the aircraft. In some instances, such advantages may become more pronounced as FPF increases and M_{tip,c}^{(RL)} value decreases (for next generation ultra-high bypass ratio engines for instance). For example, the improvement in engine performance based on the redline tip Mach number may have FPF values greater than m₁·[M_{tip,c}^{(RL)}−1.1]+0.0125, greater than m₁·[M_{tip,c}^{(RL)}−1.1]+0.04, greater than m₁·[M_{tip,c}^{(RL)}−1.1]+0.07, greater than m₁·[M_{tip,c}^{(RL)}−1.1]+0.1, or greater than m₁·[M_{tip,c}^{(RL)}−1.1]+0.2 (these other examples are schematically represented by the phantom line 202).

In another aspect, the inventors have discovered a relationship between a fan blade count “BC”, a hub-to-tip ratio of a fan “HTR”, a fan pressure ratio “FPR” of a fan, and a corrected redline fan tip Mach number “M_{tip,c}^{(RL)}” according to the below relationship, referred to herein as the Second Performance Factor (“SPF”) for a fan module:

$$SPF = \sqrt{\frac{π}{4} ( 1 - {HTR}^{2} ) / ( \frac{BC}{20} )} / ( \frac{\sqrt{FPR - 1}}{\sqrt{0.4}} ) / {M}_{tip , c}^{( RL )} - 0.97 \qquad ( 3 )$$

$${m}_{2} \cdot [ {M}_{tip , c}^{( RL )} - 1.1 ] + 1.5 > SPF > {m}_{2} \cdot [ {M}_{tip , c}^{( RL )} - 1.1 ] + Δ {y}_{2} \qquad ( 4 )$$

Regarding the hub-to-tip ratio “HTR,” a fan blade defines a hub radius (R_{hub}), which is the radius of the leading edge at the hub relative to a centerline of the fan, and a tip radius (Rₜᵢₚ), which is the radius of the leading edge at a tip of the fan blade relative to the centerline of the fan. HTR is the ratio of the hub radius to the tip radius (R_{hub}/Rₜᵢₚ). The ratio is greater than 0.1 and less than 0.5 (e.g., less than 0.275, less than 0.25, or less than 0.225).

Blade count “BC” corresponds to the number of fan blades circumferentially arranged about the fan hub. The blade count is between 10 fan blades and 40 fan blades. In certain example approaches, the blade count is less than or equal to 18 fan blades (e.g., 16 or fewer fan blades).

“FPR” and “M_{tip,c}^{(RL)}”, refer to a fan pressure ratio and a redline corrected fan tip Mach number, respectively, as discussed with respect to the average fan chord relationship above. In this way, the values of one or more of the FPR and “M_{tip,c}^{(RL)}” may be the same as those discussed with respect to the average fan chord relationship.

Referring to the inequality defined in (4) and to the plot of FIG. 4, example engine embodiments are shown having unique SPF values and corresponding redline corrected fan tip Mach number (M_{tip,c}^{(RL)}). SPF increases in value along the Y-axis, while the X-axis represents left-to-right increasing redline corrected fan tip Mach number (M_{tip,c}^{(RL)}). FIG. 4 also shows a first line 300 and a second line 302 that is offset from the first line 300 along the Y-axis. The first and second lines 300, 302 are defined by the “m₂·[M_{tip,c}^{(RL)}−1.1]+Δy₂” portion of inequality (4).

As shown in FIG. 4, the first and second lines 300, 302 are piecewise linear dividing curves; i.e., the first and second lines 300, 302 have different slopes “m₂” depending on the M_{tip,c}^{(RL)} along the X-axis. More particularly, when the value of M_{tip,c}^{(RL)} is equal to or greater than 1.1, the first and second lines 300, 302 have slopes “m₂” equal to 0.41. When the value of M_{tip,c}^{(RL)} is less than 1.1, the first and second lines 300, 302 have slopes “m₂” equal to 0.55.

As used herein, “m₂” refers to a slope of a line 300, 302, which as shown, is equal to 1. “1.1” refers to a reference corrected redline tip Mach number at which the Y-intercept is defined, and Δy₂ refers an offset from the Y-intercept along the Y-axis. The Δy₂ value can be 0.0075, 0.01, 0.02, 0.024, 0.037, 0.04, or 0.06, or can vary between 0 and 1.5, 0 and 0.0075, 0.0075 and 0.01, 0.01 and 0.2, 0.2 and 0.024, 0.024 and 0.037, 0.037 and 0.04, 0.04 and 0.6, or a value greater than 0.6 and less than 1.5.

FIG. 4 shows eight example engine embodiments, of which gas turbine engines 310, 312, 314, 316 may be referred to as low speed engine designs (as indicated by subplot area 318), and engines 320, 322, 324, 326 may be referred to as high speed engine designs (as indicated by subplot area 328). Each of the gas turbine engines 310, 312, 314, 316, 320, 322, 324, 326 have a gear ratio a range equal to or greater than 3.2 and less than or equal to 5.0.

As represented by the SPF, which indicates a particular fan blade count relationship, the inventors discovered a limited or narrowed selection of fan blade count that uniquely take into consideration other factors associated with the fan and engine type. For instance, the inventors determined that an engine having an SPF value for a given M_{tip,c}^{(RL)} value above line 300 (within plot area 340) may allow for reduced fan blade counts as compared to engines having an SPF value for a given M_{tip,c}^{(RL)} value below line 300 (within plot area 342). In this way, gas turbine engines 314, 316, 324, and 326 may provide advantages over gas turbine engines 310, 312, 320, and 322, such as a reduced cost and weight. In some instances, such advantages may become more pronounced as the SPF value increases and the M_{tip,c}^{(RL)} value decreases (for next generation ultra-high bypass ratio engines for instance). For example, the improvement in engine performance based on the redline tip Mach number may have SPF values greater than m₂. [M_{tip,c}^{(RL)}−1.1]+0.0075, greater than m₂. [M_{tip,c}^{(RL)}−1.1]+0.01, greater than m₂. [M_{tip,c}^{(RL)}−1.1]+0.02, greater than m₂. [M_{tip,c}^{(RL)}−1.1]+0.024, greater than m₂. [M_{tip,c}^{(RL)}−1.1]+0.037, greater than m₂·[M_{tip,c}^{(RL)}−1.1]+0.04, or greater than m₂·[M_{tip,c}^{(RL)}−1.1]+0.06 (these other examples are schematically represented by the phantom line 302).

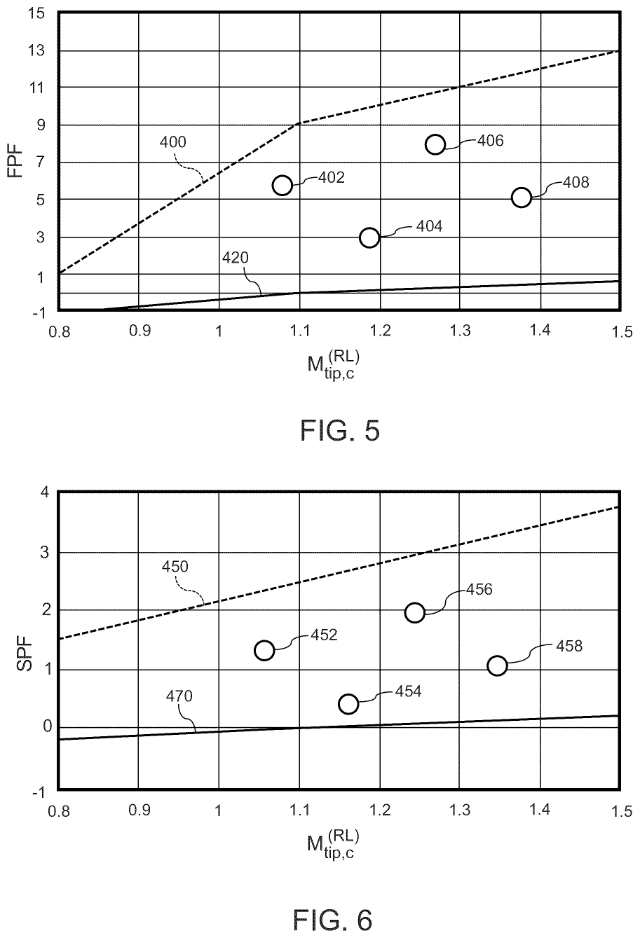

FIG. 5 shows additional example engine embodiments 402, 404, 406, 408 having First Performance Factor (FPF) values, as similarly described herein. Line 400 is a piecewise linear dividing curve having different slopes “m₁” depending on the M_{tip,c}^{(RL)} along the X-axis.

More particularly, when the value of M_{tip,c}^{(RL)} is equal to or greater than 1.1, line 400 has a slope “m₁” equal to 9.43. When the value of M_{tip,c}^{(RL)} is less than 1.1, line 400 has a slope “m₁” equal to 27.02.

Line 420 corresponds to line 200 of FIG. 3 and is similarly a piecewise linear dividing curve having different slopes “m₂” depending on the Mine along the X-axis. As with FIG. 3, when the value of M_{tip,c}^{(RL)} is equal to or greater than 1.1, the line 420 has a slope “m₂” equal to 0.87. When the value of M_{tip,c}^{(RL)} is less than 1.1, line 420 has a slope “m₂” equal to 3.34.

In this approach, the First Performance Factor (FPF) is as provided:

$$FPF = [ \frac{c}{0.15 \cdot D} ] / [ [ \frac{\sqrt{FPR - 1}}{\sqrt{0.4}} ] / {M}_{tip , c}^{( RL )} ] - 1.23 \qquad ( 5 )$$

$${m}_{1} \cdot [ {M}_{tip , c}^{( RL )} - 1.1 ] + 9.14 > FPF > {m}_{2} \cdot [ {M}_{tip , c}^{( RL )} - 1.1 ] \qquad ( 6 )$$

The First Performance Factor (FPF) values may be in the range, for example, equal to or greater than −0.8 and equal to or less than 8.4, equal to or greater than 0 and equal to or less than 6, or equal to or greater than 1 and equal to or less than 2. M_{tip,c}^{(RL)} values may be within a range equal to or greater than 0.8 and equal to or less than 1.5, or equal to or greater than 0.9 and equal to or less than 1.4. FPR values may be within a range equal to or greater than 1.2 and equal to or less than 1.6, equal to or greater than 1.3 and equal to or less than 1.5, or equal to or greater than 1.35 and equal to or less than 1.45.

FIG. 6 shows additional example engine embodiments 452, 454, 456, 458 having Second Performance Factor (SPF) values, as similarly described herein. Line 450 is a linear curve having slope “m₃” of 3.17. Line 470 corresponds to line 300 of FIG. 4 and is similarly a piecewise linear dividing curve having different slopes “m₄” depending on the M_{tip,c}^{(RL)} along the X-axis. More particularly, when the value of M_{tip,c}^{(RL)} is equal to or greater than 1.1, line 470 has a slope “m₄” equal to 0.41. When the value of M_{tip,c}^{(RL)} is less than 1.1, line 420 has a slope “m₄” equal to 0.55.

In this approach, the Second Performance Factor (SPF) is as provided:

$$SPF = \sqrt{\frac{π}{4} ( 1 - {HTR}^{2} ) / ( \frac{BC}{20} )} / ( \frac{\sqrt{FPR - 1}}{\sqrt{0.4}} ) / {M}_{tip , c}^{( RL )} - 0.97 \qquad ( 7 )$$

$${m}_{3} \cdot [ {M}_{tip , c}^{( RL )} - 1.1 ] + 2.52 > SPF > {m}_{4} \cdot [ {M}_{tip , c}^{( RL )} - 1.1 ] \qquad ( 8 )$$

The Second Performance Factor (SPF) values may be in the range, for example, equal to or greater than 0.087 and equal to or less than 2.4, or equal to or greater than 1 and equal to or less than 2. M_{tip,c}^{(RL)} values may be within a range equal to or greater than 0.8 and equal to or less than 1.5, or equal to or greater than 0.9 and equal to or less than 1.4. HTR values may be within a range equal to or greater than 0.2 and equal to or less than 0.4, or equal to or greater than 0.25 and equal to or less than 0.35.

The inventors have discovered a relationship between the First Performance Factor and Second Performance Factor described herein. More particularly, the inventors discovered that engine designs achieving each of the First Performance Factor and Second Performance Factor, without significant changes in solidity, provide improved engine performance. Blade solidity is defined as the ratio of the blade chord length to the distance of space between the blades.

Example engine parameters and corresponding First Performance Factors and Second Performance Factors are presented in Table 1 below.

TABLE 1

| Example | HTR | FPR | M_{tip, c}^{(RL)} | SPF | FPF |
|---|---|---|---|---|---|
| 1 | 0.206 | 1.522 | 1.417 | 1.782 | 2.374 |
| 2 | 0.400 | 1.376 | 1.421 | 0.981 | 0.976 |
| 3 | 0.260 | 1.204 | 1.177 | 0.823 | 2.722 |
| 4 | 0.224 | 1.595 | 0.976 | 0.646 | −0.359 |
| 5 | 0.213 | 1.517 | 0.815 | 0.613 | −0.823 |
| 6 | 0.265 | 1.448 | 1.497 | 1.152 | 1.161 |
| 7 | 0.352 | 1.250 | 0.962 | 0.087 | −0.445 |
| 8 | 0.394 | 1.328 | 1.228 | 2.403 | 6.606 |
| 9 | 0.213 | 1.517 | 0.815 | 0.613 | −0.823 |
| 10 | 0.235 | 1.240 | 1.231 | 2.053 | 8.398 |

In this way, using fan parameters such as fan pressure ratios, corrected fan tip Mach number, fan diameters, and hub-to-tip ratios, the inventors discovered approaches that utilize the above-described average fan chord relationship to obtain an average chord width, and the above-described fan blade count relationship to obtain a fan blade count. These obtained constraints guide one to select fan chord width, blade count, or both suited for the particularized engine architectures and mission requirements, informed by engine-unique environments and trade-offs in design (as discussed above), which are believed to result in an improved engine.

In another aspect, the FPF and SPF may also be useful as a design tool for down-selecting, or providing a guideline for reducing the number of candidate designs for fan blade counts and average fan chords from which to design a fan module for a particular architecture. In this way, an engine architecture is improved overall by knowing, early in the design process, what constraints or limitations would be imposed by a fan module given the mission objectives.

In another aspect method of assembly is provided. The method includes mounting a fan inside an annular casing for rotation about an axial centerline. The fan including fan blades that extend radially outwardly toward the annular casing. The fan further includes an average fan chord width according to the First Performance Factor (“FPF”) and/or a quantity of fan blades according to the Second Performance Factor (“SPF”) discussed above.

Also disclosed herein is a non-metallic leading edge protective wrap that can protect a leading edge of an airfoil having a composite core. For example, the leading edge protective wrap protects against erosion and foreign object damage, such as from bird strikes. The leading edge protective wrap includes a trailing wrap wrapped around a core leading edge of the composite core and is connected to a pressure sidewall and suction sidewall of the composite core. The leading edge protective wrap also includes a leading edge wrap wrapped around the core leading edge and a leading edge of the trailing wrap. Accordingly, the leading wrap is an outer wrap with respect to the trailing wrap.

The non-metallic leading edge protective wrap disclosed herein offers several advantages. For example, the non-metallic leading edge protective wrap is less likely to break away from the composite core of the airfoil during operation of the core turbine engine, which would expose the composite core to the elements and possible foreign object damage (FOD). Additionally, the non-metallic leading edge protective wrap may wrap unbroken around the core leading edge, which can improve ruggedness of the airfoil and prevent structural damage to the airfoil.

The non-metallic leading edge protective wrap disclosed herein was moreover found particularly advantageous for a fan module contemplated by the above relationships (1) through (4). For example, the First Performance Factor (FPF) and Second Performance Factor (SPF) parameters drive the fan blade design towards a lower corrected fan tip speed (U_{c(tip)}). A lower corrected fan tip speed (U_{c(tip)}) lowers the relative velocities of foreign objects that may cause FOD, such as from bird strikes. This allows for a deviation from traditional metallic leading-edge protections to a non-metallic leading edge. Non-metallic leading edges have the advantage of potentially co-curing with a composite airfoil base, eliminating the need for secondary bonding of the leading edge, and thus improving manufacturing processes.

Moreover, the First Performance Factor (FPF) and Second Performance Factor (SPF) parameters driving the fan blade design towards a lower corrected fan tip speed (U_{c(tip)}) also allows for the selection of a lower fan chord and potentially a reduced blade count (BC). This reduction in fan chord or tip speed, and particularly a reduction in both fan chord and tip speed, enables the use of a lighter non-metallic leading edge, which synergistically improves the efficiency of the engine (with FPF and SPF) by reducing the overall system weight and enhancing fuel efficiency.

Such reduction in fan chord or tip speed may also result in aerodynamic losses resulting from the fan blade leading edge profile along an airfoil being more exposed to the aerodynamic flow path. The non-metallic leading edge protective wrap discussed herein can therefore be integrated into the fan module contemplated by the above relationships (1) through (4) to further improve performance of the gas turbine engine. For example, the non-metallic leading edge protective wrap may improve aerodynamic flow through the fan, thereby improving fuel consumption, reducing or even eliminating the undesirable aerodynamic losses noted above. The non-metallic leading edge protective wrap may also improve the structural integrity of the airfoil and protect the fan blades from erosion and foreign object damage.

Additionally, the First Performance Factor (FPF) may drive the corrected redline fan tip Mach number (M_{tip,c}^{(RL)} below 1.1, which allows for selection of a fan blade design having reduced blade stiffness. The non-metallic leading edge protective wrap discussed herein may counteract the risks associated with a fan blade having reduced blade stiffness by improving the structural integrity of the fan blade.

Accordingly, integration of the non-metallic leading edge protective wrap technology with the relationships discussed hereinabove (relationships (1) through (4), above) results in a gas turbine engine having synergistic engine improvements in terms of aerodynamic efficiency, fuel efficiency, and durability.

As disclosed herein, fan parameters such as fan pressure ratios, corrected fan tip speeds, fan diameters, and hub-to-tip ratios may be used to select a fan chord width, a blade count, or both to provide a gas turbine engine having improved engine aerodynamic efficiency and/or improved fuel efficiency. During the course of designing a more efficient gas turbine engine, it was found that increasing a cooling capacity for various accessories of the gas turbine engine further provides for a more efficient gas turbine engine.

In particular embodiments, a turbomachine, or a core turbine engine, of the gas turbine engine defines a cooling passage extending between an inlet and an outlet with the inlet in airflow communication with a working gas flow path of the turbomachine at a location upstream of a compressor section. The outlet is in airflow communication with a bypass passage. The turbomachine also includes a heat exchanger in thermal communication with an airflow through the cooling passage for cooling one or more accessory systems of the gas turbine engine. Such a configuration can increase a cooling capacity for the gas turbine engine, enabling integration of relatively heat-intensive accessory systems to further improve an efficiency of the gas turbine engine. For example, inclusion of a reduction gearbox may allow for a low pressure turbine of the gas turbine engine to operate at higher speeds while maintaining a relatively low rotational speed for the fan. This can allow for improved efficiency of various components of the turbomachine, while maintaining, or even reducing a fan pressure ratio of the fan. The increased cooling capacity facilitated by the cooling passage and heat exchanger as set forth above may allow for inclusion of such a reduction gearbox.

The reduction gearbox and additional cooling features described herein have more particularly been found to be advantageous for the fan module contemplated by the above relationships (1) through (4) to further improve performance of the gas turbine engine. For example, the First Performance Factor (FPF) and Second Performance Factor (SPF) parameters drive the fan blade design towards a lower corrected redline fan tip Mach number (M_{tip,c}^{(RL)}. A lower corrected redline fan tip Mach number (M_{tip,c}^{(RL)} may result in a higher gear ratio and increased heat generation, which increases the amount of cooling required. The First Performance Factor (FPF) and Second Performance Factor (SPF) parameters also drive the fan blade design towards a reduced fan pressure ratio (“FPR”). Reducing the fan pressure ratio (“FPR”) may require more surface coolers in the bypass duct, which negatively impacts the fan stream velocity and net fuel burn.

Therefore, inclusion of the additional cooling features described herein may provide additional cooling to counteract the risks associated with a fan blade design having a lower corrected redline fan tip Mach number (M_{tip,c}^{(RL)} and a reduced fan pressure ratio (“FPR”). Additionally, integration of the additional cooling features described herein can enable, e.g., inclusion of a reduction gearbox with sufficient cooling to allow the fan to rotate at a fan speed contemplated by the above relationships (1) through (4), without sacrificing efficiencies within the various components of the turbomachine, such as a low pressure turbine. Moreover, increasing cooling capacity can additionally or alternatively allow for inclusion of one or more other accessory systems for the gas turbine engine to improve engine efficiency, such as a cooled cooling air (CCA) system.

Accordingly, the present disclosure provides additional cooling features in combination with the relationships (1) through (4) disclosed herein resulting in a gas turbine engine having improved aerodynamic efficiency, fuel efficiency, and cooling capacity.

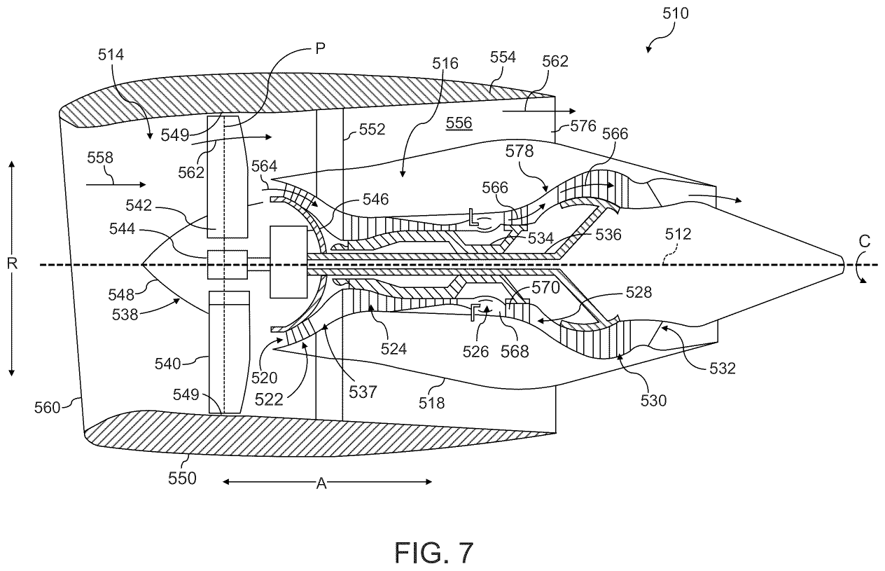

FIG. 7 is a schematic cross-sectional view of a gas turbine engine 510 in accordance with an exemplary embodiment of the present disclosure. More particularly, for the embodiment of FIG. 7, the gas turbine engine 510 is a high-bypass turbofan jet engine, sometimes also referred to as a “turbofan engine.” As shown in FIG. 7, the gas turbine engine 510 defines an axial direction A (extending parallel to a longitudinal centerline 512 provided for reference), a radial direction R, and a circumferential direction C extending about the longitudinal centerline 512. In general, the gas turbine engine 510 includes a fan section 514 and a core turbine engine 516 disposed downstream from the fan section 514, the core turbine engine 516 drivingly coupled to a fan 538 of the fan section 514.

The exemplary core turbine engine 516 depicted generally includes a substantially tubular outer casing 518 that defines an annular inlet 520. The outer casing 518 encases, in serial flow relationship, a compressor section including a booster or low pressure (LP) compressor 522 and a high pressure (HP) compressor 524; a combustion section 526; a turbine section including a high pressure (HP) turbine 528 and a low pressure (LP) turbine 530; and a jet exhaust nozzle section 532. A high pressure (HP) shaft 534 (which may additionally or alternatively be a spool) drivingly connects the HP turbine 528 to the HP compressor 524. A low pressure (LP) shaft 536 (which may additionally or alternatively be a spool) drivingly connects the LP turbine 530 to the LP compressor 522. The compressor section, combustion section 526, turbine section, and jet exhaust nozzle section 532 together define a working gas flow path 537. In such a manner, it will be appreciated that the annular inlet 520 is an inlet to the working gas flow path 537.

In the embodiment shown, the annular inlet 520 is positioned immediately downstream of the fan 538 (i.e., no intervening structure, such as blades, vanes, or struts, therebetween). Further, it will be appreciated that for the embodiment depicted, the LP compressor 522 is located downstream of the fan 538, and there are no intermediate stages of compression between the fan 538 and the LP compressor 522.

As shown in FIG. 7, the fan section 514 may include a fan 538 having a plurality of fan blades 540 coupled to a disk 542 in a spaced apart manner. As depicted, the fan 538 is a single stage fan and the fan blades 540 extend outwardly from disk 542 generally along the radial direction R. Each fan blade 540 is rotatable relative to the disk 542 about a pitch axis P by virtue of the fan blades 540 being operatively coupled to a suitable pitch change mechanism 544 configured to collectively vary the pitch of the fan blades 540, e.g., in unison. The gas turbine engine 510 further includes a reduction gearbox 546, and the fan blades 540, disk 542, and pitch change mechanism 544 are together rotatable about the longitudinal centerline 512 by LP shaft 536 across the reduction gearbox 546. The reduction gearbox 546 includes a plurality of gears for adjusting a rotational speed of the fan 538 relative to a rotational speed of the LP shaft 536, such that the fan 538 may rotate at a more efficient fan speed.

Still referring to FIG. 7, the disk 542 is covered by a rotatable front hub 548 of the fan section 514 (sometimes also referred to as a “spinner”). The front hub 548 is aerodynamically contoured to promote an airflow through the plurality of fan blades 540.

Additionally, the exemplary fan section 514 includes an annular fan casing or outer nacelle 550 that circumferentially surrounds the fan 538 and/or at least a portion of the core turbine engine 516. It should be appreciated that the outer nacelle 550 is supported relative to the core turbine engine 516 by a plurality of circumferentially-spaced outlet guide vanes 552 in the embodiment depicted. Moreover, a downstream section 554 of the outer nacelle 550 extends over an outer portion of the core turbine engine 516 so as to define a bypass passage 556 therebetween. The bypass passage 556 is defined at least partially over the core turbine engine 516.

During operation of the gas turbine engine 510, a volume of air 558 enters the gas turbine engine 510 through an associated inlet 560 of the outer nacelle 550 and fan section 514. As the volume of air 558 passes across the fan blades 540, a first portion of air 562 is directed or routed into the bypass passage 556 and a second portion of air 564 as indicated by arrow 564 is directed or routed into the working gas flow path 537, or more specifically into the LP compressor 522. The ratio between the first portion of air 562 and the second portion of air 564 is commonly known as a bypass ratio. A pressure of the second portion of air 564 is then increased as it is routed through the HP compressor 524 and into the combustion section 526, where it is mixed with fuel and burned to provide combustion gases 566.

The combustion gases 566 are routed through the HP turbine 528 where a portion of thermal and/or kinetic energy from the combustion gases 566 is extracted via sequential stages of HP turbine stator vanes 568 that are coupled to the outer casing 518 and HP turbine rotor blades 570 that are coupled to the HP shaft 534, thus causing the HP shaft 534 to rotate, thereby supporting operation of the HP compressor 524. The combustion gases 566 are then routed through the LP turbine 530 where a second portion of thermal and kinetic energy is extracted from the combustion gases 566 via sequential stages of LP turbine stator vanes 572 that are coupled to the outer casing 518 and LP turbine rotor blades 574 that are coupled to the LP shaft 536, thus causing the LP shaft 536 to rotate, thereby supporting operation of the LP compressor 522 and/or rotation of the fan 538.

The combustion gases 566 are subsequently routed through the jet exhaust nozzle section 532 of the core turbine engine 516 to provide propulsive thrust. Simultaneously, the pressure of the first portion of air 562 is substantially increased as the first portion of air 562 is routed through the bypass passage 556 before it is exhausted from a fan nozzle exhaust section 576 of the gas turbine engine 510, also providing propulsive thrust. The HP turbine 528, the LP turbine 530, and the jet exhaust nozzle section 532 at least partially define a hot gas path 578 for routing the combustion gases 566 through the core turbine engine 516.

It should be appreciated, however, that the exemplary gas turbine engine 510 depicted in FIG. 7 is by way of example only, and that in other exemplary embodiments, the gas turbine engine 510 may have any other suitable configuration. For example, although the gas turbine engine 510 depicted is configured as a ducted gas turbine engine (i.e., including the outer nacelle 550), in other embodiments, the gas turbine engine 510 may be an unducted gas turbine engine (such that the fan 538 is an unducted fan, and the outlet guide vanes 552 are cantilevered from the outer casing 518). Additionally, or alternatively, although the gas turbine engine 510 depicted is configured as a geared gas turbine engine (i.e., including the reduction gearbox 546) and a variable pitch gas turbine engine (i.e., including a fan 538 configured as a variable pitch fan), in other embodiments, the gas turbine engine 510 may additionally or alternatively be configured as a direct drive gas turbine engine (such that the LP shaft 536 rotates at the same speed as the fan 538), as a fixed pitch gas turbine engine (such that the fan 538 includes fan blades 540 that are not rotatable about a pitch axis P), or both. It should also be appreciated, that in still other exemplary embodiments, aspects of the present disclosure may be incorporated into any other suitable gas turbine engine. For example, in other exemplary embodiments, aspects of the present disclosure may (as appropriate) be incorporated into, e.g., a turboprop gas turbine engine, a turboshaft gas turbine engine, or a turbojet gas turbine engine.

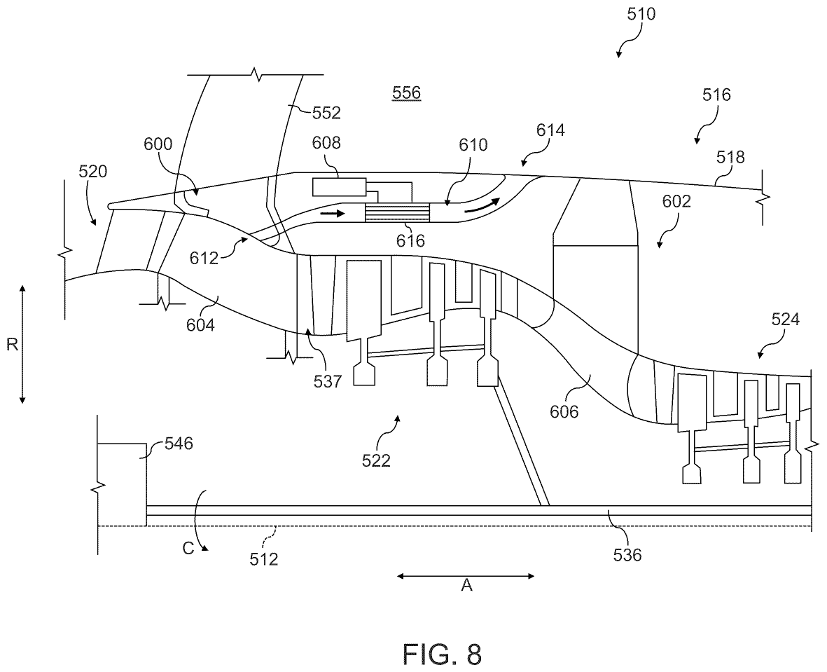

With reference to FIG. 8, a close-up, schematic view is depicted of a portion of the exemplary gas turbine engine 510 of FIG. 7. In particular, the view of FIG. 8 is a close-up of the core turbine engine 516 of FIG. 7, depicting the annular inlet 520, the compressor section including the LP compressor 522 and the HP compressor 524, the LP shaft 536, and the reduction gearbox 546. Further, the outer casing 518 of the core turbine engine 516 is depicted extending around at least a portion of the compressor section, with the bypass passage 556 defined in part thereby.

As shown in FIG. 8, the core turbine engine 516 may further include a compressor forward frame 600 and a compressor mid-frame 602. The compressor forward frame 600 includes a strut 604 extending through the working gas flow path 537 at a location upstream of the LP compressor 522 and downstream of the annular inlet 520. Similarly, the compressor mid-frame 602 includes a strut 606 extending through the working gas flow path 537 at a location downstream of the LP compressor 522 and upstream of the HP compressor 524. The compressor forward frame 600 and the compressor mid-frame 602 may provide structural support to various components of the gas turbine engine 510.

As will be appreciated, the exemplary gas turbine engine 510 depicted includes one or more accessory systems 608 for facilitating operations of the gas turbine engine 510. The one or more accessory systems 608 may include one or more of an oil lubrication system, a fuel delivery system, a cooled cooling air (CCA) system, an engine controller cooling system, etc. A single accessory system 608 is depicted schematically in FIG. 8 by way of example.

Moreover, in order to assist with cooling the one or more accessory systems 608, such as the accessory system 608 depicted, the core turbine engine 516 further defines an annular cooling passage 610 extending between a cooling passage (CP) inlet 612 and a CP outlet 614.

The CP inlet 612 is in airflow communication with the working gas flow path 537 at a location upstream of the compressor section of the core turbine engine 516. More specifically, for the embodiment depicted, the CP inlet 612 is in airflow communication with the working gas flow path 537 at a location upstream of the LP compressor 522 and downstream of the annular inlet 520. More specifically, still, for the embodiment shown, the CP inlet 612 is aligned with the compressor forward frame 600 along the axial direction A of the gas turbine engine 510. In such a manner, the CP inlet 612 is configured to receive an airflow from the working gas flow path 537 that is been compressed by the fan 538 of the fan section 514 (see FIG. 7). For example, a pressure of an airflow received through the CP inlet 612 and provided to the cooling passage 610 may be substantially equal (e.g., within 10% of) to a pressure of the airflow provided through the annular inlet 520.

Still referring to FIG. 8, the CP outlet 614 is in airflow communication with the bypass passage 556. In particular, for the embodiment shown, the CP outlet 614 is in airflow communication with the bypass passage 556 at a location aft of the CP inlet 612 and forward of the compressor mid-frame 602. In particular, for the embodiment shown, the CP outlet 614 is aligned with the compressor section along the axial direction A.

Further, the core turbine engine 516 includes a heat exchanger 616 that is in thermal communication with the airflow through the cooling passage 610. In particular, the heat exchanger 616 is positioned within the cooling passage 610 or defines a portion of the cooling passage 610. In such a manner, the heat exchanger 616 may be configured to transfer heat from a fluid to the airflow through the cooling passage 610.

In particular, for the embodiment shown the heat exchanger 616 is further in thermal communication with the accessory system 608 of the gas turbine engine 510 for transferring heat from the accessory system 608 to the airflow through the cooling passage 610. In such a manner the cooling passage 610 may provide cooling for the accessory system 608.

It will be appreciated that for the embodiment shown, although a single heat exchanger 616 and a single accessory system 608 are depicted, in other exemplary embodiments, other suitable configurations may be provided.

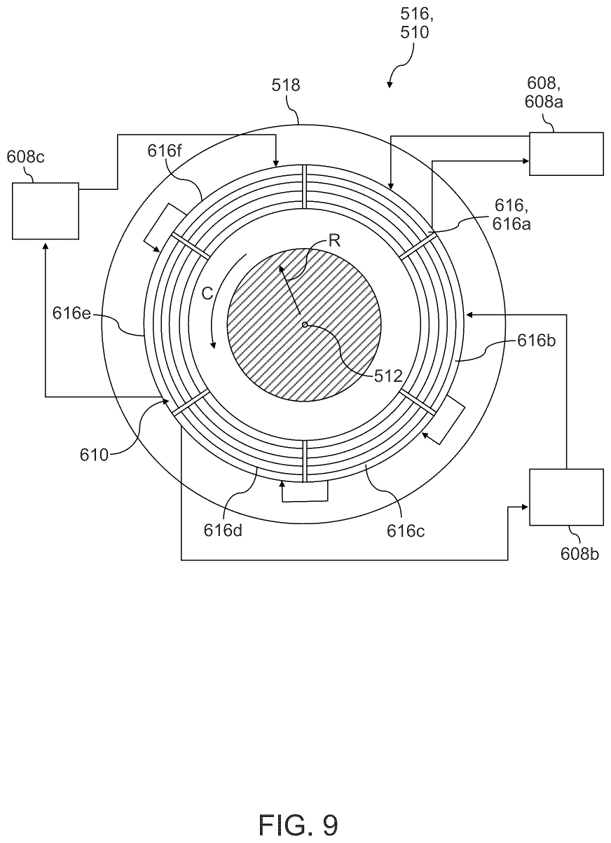

For example, with reference to FIG. 9, a schematic, cross-sectional view of a core turbine engine 516 including a cooling passage 610 in accordance with an exemplary aspect of the present disclosure is provided. The exemplary cooling passage 610 and heat exchanger 616 of FIG. 9 may be configured in a similar manner as exemplary cooling passage 610 and heat exchanger 616 described above with reference to FIG. 8.

However, for the embodiment shown, the heat exchanger 616 is a first heat exchanger 616A of a plurality of heat exchangers 616 arranged along a circumferential direction C of the gas turbine engine 510. The plurality of heat exchangers 616 are each positioned within the cooling passage 610.

Notably, for the embodiment shown, the accessory system 608 is also a first accessory system 608A of a plurality of accessory systems 608. Each of the plurality of accessory systems 608 utilizes one or more of the plurality of heat exchangers 616. For example, the first accessory system 608A is in thermal communication with the first heat exchanger 616A. A second accessory system 608B of the plurality of accessory systems 608 is in thermal communication with a second heat exchanger 616B, a third heat exchanger 616C, and a fourth heat exchanger 616D. Notably, the second heat exchanger 616B, the third heat exchanger 616C, and the fourth heat exchanger 616D are arranged in serial flow order. Further, a third accessory system 608C of the plurality of accessory systems 608 is in thermal communication with a fifth heat exchanger 616E and a sixth heat exchanger 616F.

In such a manner, it will be appreciated that an airflow through the cooling passage 610 may be utilized as a heat sink for a variety of accessory systems 608 of the gas turbine engine 510.

Moreover, it will be appreciated that in other exemplary embodiments, other suitable structures may be provided to assist with generating an airflow through the cooling passage 610 of the present disclosure.

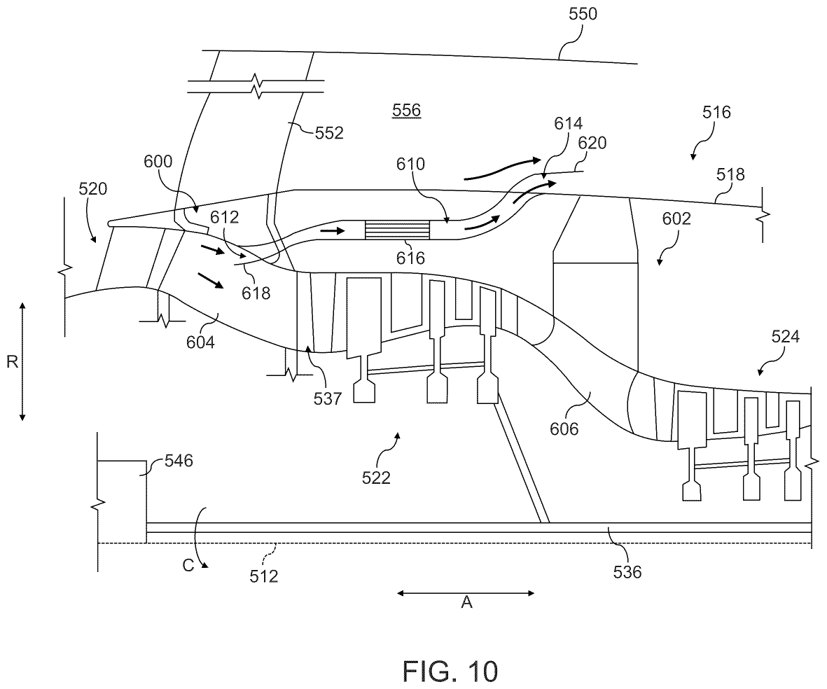

For example, referring now to FIG. 10, a close-up, schematic view of a gas turbine engine 510 in accordance with another exemplary aspect of the present disclosure is provided. The exemplary gas turbine engine 510 depicted in FIG. 10 may be configured in a similar manner as the exemplary gas turbine engine 510 described above with reference to FIGS. 7 and 8. The same or similar numbers may refer to the same or similar part.

For example, the exemplary gas turbine engine 510 depicted in FIG. 10 generally includes a core turbine engine 516 defining a cooling passage 610 extending between a CP inlet 612 and a CP outlet 614. The CP inlet 612 is in airflow communication with a working gas flow path 537 of the core turbine engine 516 at a location upstream of a compressor section of the core turbine engine 516. The CP outlet 614 is in airflow communication with a bypass passage 556 of the gas turbine engine 510 defined between an outer nacelle 550 and the core turbine engine 516.

Notably, as with the embodiment above, the CP inlet 612 is configured to receive an airflow compressed by a fan 538 of the gas turbine engine 510 (see FIG. 7), but is positioned upstream of any additional stages of compression. Accordingly, in order to assist with generating an airflow through the cooling passage 610, the core turbine engine 516 includes a means for urging the airflow through the cooling passage 610.

More specifically, for the embodiment depicted, the means includes an inlet scoop 618 extending into the working gas flow path 537 at the CP inlet 612 to divert a portion of an airflow through the working gas flow path 537 through the CP inlet 612 of the cooling passage 610. In the embodiment depicted, the inlet scoop 618 is an annular scoop extending 360° about a longitudinal centerline 512 of the gas turbine engine 510. Further, for the embodiment depicted, the inlet scoop 618 is a fixed structure.

However, it will be appreciated that in other exemplary embodiments, the inlet scoop 618 may instead be configured in any other suitable manner (e.g., may be configured as a plurality of individual inlet scoops 618 arranged along a circumferential direction C of the gas turbine engine 510, may be a variable scoop capable of being deployed and retracted, etc.).

Further, for the embodiment depicted, the means for urging the airflow through the cooling passage 610 additionally includes a hood 620 extending over the CP outlet 614 of the cooling passage 610. The hood 620 extends into the bypass passage 556, such that a cross-sectional area of the bypass passage 556 at the hood 620 is less than a cross-sectional area of the bypass passage 556 immediately upstream of the hood 620. In such a manner, the hood 620 may form a nozzle to increase a speed of an airflow through the bypass passage 556, reducing a static pressure at the CP outlet 614 of the cooling passage 610. As such, the hood 620 may generate a delta pressure to urge the airflow through the cooling passage 610.

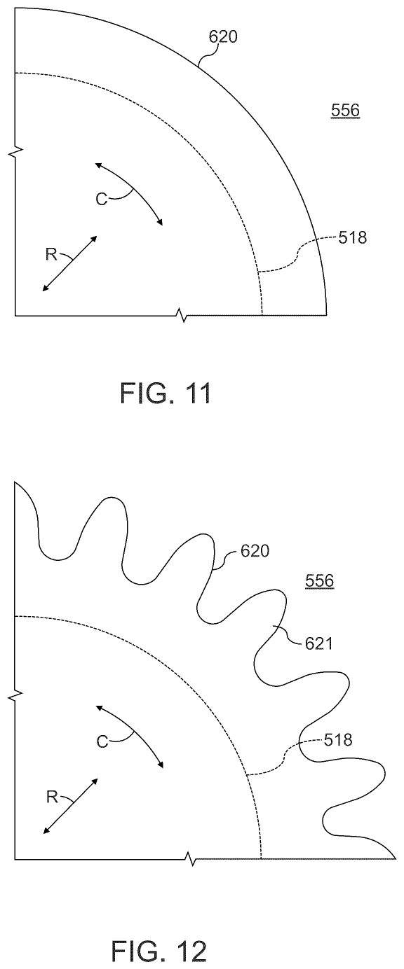

Briefly, referring to FIG. 11, a partial, schematic, cross-sectional view of the hood 620 is depicted, as viewed along the axial direction A. As shown, for the embodiment depicted, the hood 620 is a relatively smooth hood 620.

Alternatively, referring briefly to FIG. 12, partial, schematic, cross-sectional view of a hood 620 in accordance with another exemplary embodiment of the present disclosure, as may be incorporated into the gas turbine engine 510 of FIG. 10 is depicted. For the embodiment of FIG. 12, the hood 620 is configured as a mixer having a plurality of lobes 621 spaced along a circumferential direction C having sequential peaks and valleys, such that a radial height of the hood 620 (and lobes 621) defines a sinusoidal pattern along the circumferential direction C. The plurality of lobes 621 may raise the radial height of the hood 620 locally along the circumferential direction C and therefore maximally reduce an exit static pressure at the CP outlet 614 at such local position by increasing the fan airflow Mach number at the local position over the lobe 621 of the hood 620.

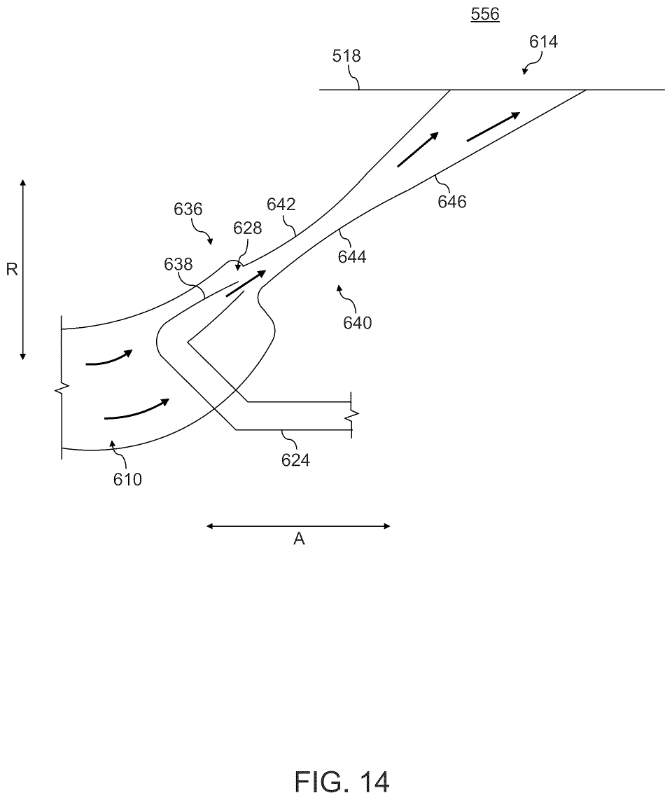

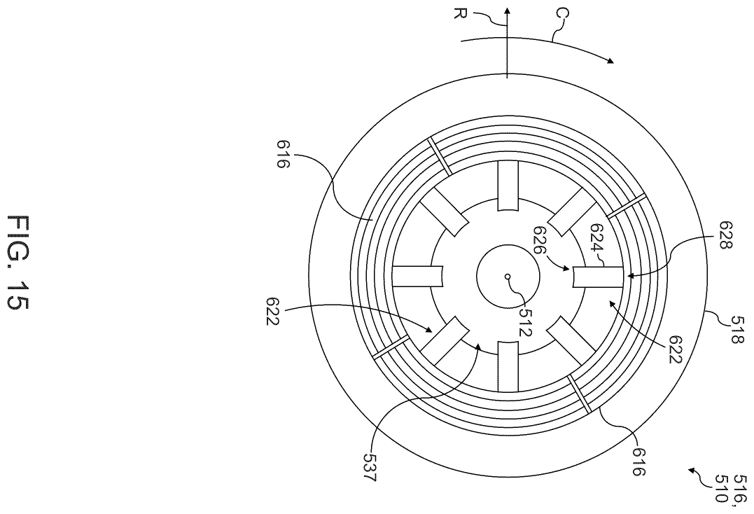

Further, still, in other exemplary embodiments, the means for urging the airflow through the cooling passage 610 may be any other suitable means, such as a pump or compressor, or an ejector in airflow communication with a high-pressure air source. For example, in certain exemplary embodiments, the means may include an ejector in airflow communication with a variable bleed assembly, and further in airflow communication with the cooling passage 610 (see, e.g., FIG. 14 below). Alternatively, in other embodiments, the high pressure air source may be any other suitably high pressure air source, such as an LP compressor bleed, an HP compressor bleed, a turbine exhaust bleed, or a combination thereof. In certain embodiments, the ejector may be positioned downstream of the heat exchanger 616 (as shown in FIG. 14). Alternatively, in other embodiments, the ejector may be positioned upstream of the heat exchanger 616 (FIGS. 8 and 10).

Referring again to FIGS. 8 and 10, in one or more of the above exemplary embodiments, it will be appreciated that the cooling passage 610 may be configured to receive sufficient air flow therethrough to provide a desired amount of cooling to the one or accessory systems 608 of the gas turbine engine 510. For example, in certain exemplary embodiments, it will be appreciated that during operation of the gas turbine engine 510 at a first operating condition, the cooling passage 610 may be configured to receive between 2% and 20% of the total airflow through the working gas flow path 537 at a location upstream of the CP inlet 612 and downstream of the annular inlet 520. For example, in certain exemplary embodiments, the cooling passage 610 may be configured to receive between 4% and 12% of the total airflow through the working gas flow path 537 at the location upstream of the CP inlet 612 and downstream of the annular inlet 520. In certain exemplary aspects, the first operating condition may be a high power operating condition (e.g., a takeoff operating condition), wherein a relatively high amount of cooling may be desirable for the gas turbine engine 510.

It will be appreciated that including a core turbine engine defining a cooling passage in accordance with one or more exemplary aspects of the present disclosure may allow for a relatively cool airflow to be utilized for cooling one or accessory systems of the gas turbine engine prior to such airflow being subjected to additional stages of compression. In such a manner, the cooling passage may provide for a relatively efficient way to cool the various accessory systems, as the airflow is utilized prior to work in the form of compression having been applied thereto. Further, by transferring heat to such airflow prior to such airflow being provided to the bypass passage, additional energy may be transferred to the bypass passage, which may increase an overall propulsive efficiency of the gas turbine engine.

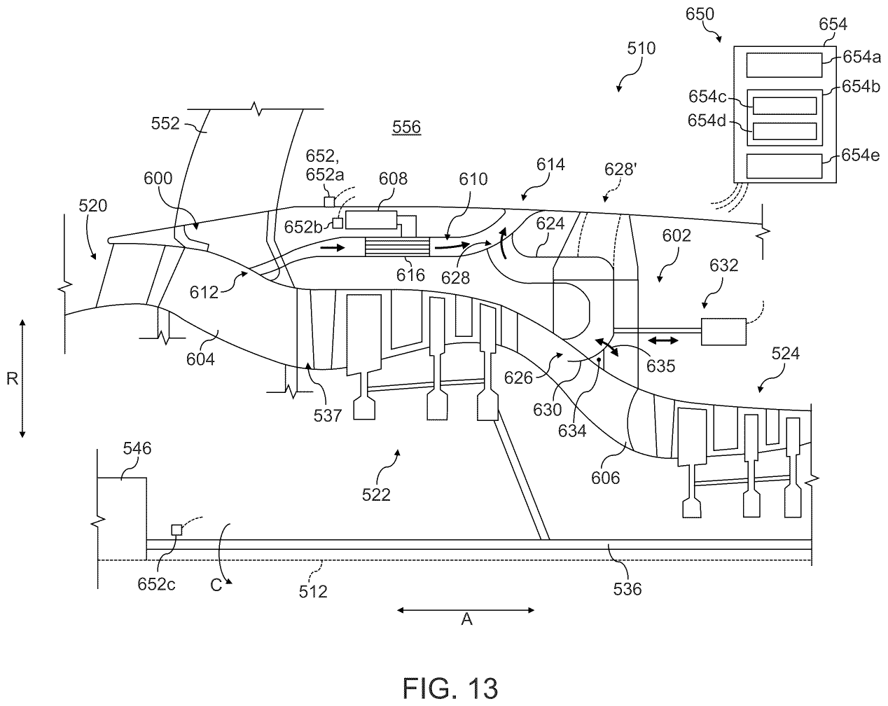

Referring now to FIG. 13, a close-up, schematic view of a gas turbine engine 510 in accordance with yet another exemplary aspect of the present disclosure is provided. The exemplary gas turbine engine 510 depicted in FIG. 13 may be configured in a similar manner as exemplary gas turbine engine 510 described above with reference to FIGS. 7 and 8. The same or similar numbers may refer to the same or similar part.

For example, the exemplary gas turbine engine 510 depicted in FIG. 13 generally includes a core turbine engine 516 defining a cooling passage 610 extending between a CP inlet 612 and a CP outlet 614. The CP inlet 612 is in airflow communication with a working gas flow path 537 of the core turbine engine 516 at a location upstream of a compressor section of the core turbine engine 516. The CP outlet 614 is in airflow communication with a bypass passage 556 of the gas turbine engine 510 defined between an outer nacelle 550 (not shown; see FIG. 7) and the core turbine engine 516.

Notably, as with the embodiment above, the CP inlet 612 is configured to receive an airflow compressed by a fan 538 of the gas turbine engine 510 (see FIG. 7), but is positioned upstream of any additional stages of compression. Accordingly, in order to assist with generating an airflow through the cooling passage 610, the core turbine engine 516 includes a means for urging the airflow through the cooling passage 610.

More specifically, for the embodiment of FIG. 13, the gas turbine engine 510 further includes a variable bleed assembly 622. The variable bleed assembly 622 includes a variable bleed duct 624 extending between a VB inlet 626 and a VB outlet 628.

The VB inlet 626 is in airflow communication with the working gas flow path 537 at a location downstream the CP inlet 612. In particular, for the embodiment depicted, the CP inlet 612 is in airflow communication with the working gas flow path 537 at a location upstream of a compressor of the compressor section, and more specifically, of an LP compressor 522 of the compressor section, and the VB inlet 626 is in airflow communication with the working gas flow path 537 at a location downstream of the LP compressor 522. More specifically, still, for the embodiment shown, the VB inlet 626 is in airflow communication with the working gas flow path 537 at a location upstream of an HP compressor 524 and aligned with a compressor mid-frame 602 of the core turbine engine 516 along an axial direction A of the gas turbine engine 510.

Referring still to FIG. 13, the VB outlet 628 is in airflow communication with the cooling passage 610. More specifically, for the embodiment depicted the VB outlet 628 is in airflow communication with the cooling passage 610 at a location downstream of a heat exchanger 616 (the heat exchanger 616 being in thermal communication with an airflow through the cooling passage 610).

As will be appreciated from the exemplary embodiment depicted in FIG. 13, in the embodiment depicted, substantially all of an airflow through the variable bleed duct 624 (i.e., at least 90% of the airflow through the variable bleed duct 624) is provided through the VB outlet 628 to the cooling passage 610.

It will be appreciated, however, that in other embodiments, it may not be necessary to provide substantially all of the airflow through the variable bleed duct 624 to the cooling passage 610 through the VB outlet 628. In such a manner, the VB outlet 628 may be a first VB outlet, and the variable bleed duct 624 may further include a second VB outlet 628′. The second VB outlet 628′, as is depicted in phantom may be in direct airflow communication with the bypass passage 556 (i.e., may provide the airflow from the variable bleed duct 624 to the bypass passage 556 without merging or mixing with any other airflow upstream of the bypass passage 556). In the embodiment depicted, the variable bleed duct 624 splits to extend to both the first VB outlet 628 and the second VB outlet 628′.

As will be appreciated, providing the airflow through the variable bleed duct 624 to the cooling passage 610 through the VB outlet 628 may urge the airflow through the cooling passage 610. In such a manner, the variable bleed assembly 622 may be a means for urging the airflow through the cooling passage 610.

In order to modulate the amount of airflow through the cooling passage 610, the variable bleed assembly 622 may be capable of varying an amount of airflow provided therethrough to the cooling passage 610. In particular, for the embodiment of FIG. 13, the variable bleed assembly 622 includes a variable bleed valve 630 for varying the amount of airflow through the variable bleed duct 624. In the embodiment depicted, the variable bleed valve 630 is located at an upstream end of the variable bleed duct 624 and includes the VB inlet 626.

More specifically, for the embodiment depicted the variable bleed assembly 622 further includes an actuator 632 coupled to the variable bleed valve 630 configured to actuate the variable bleed valve 630 about a pin 634, to pivot the variable bleed valve 630 between a deployed position (shown) and a stowed position (not shown), and optionally various positions therebetween, as is illustrated by arrow 635. The variable bleed valve 630 may be moved from the deployed position to the stowed position by rotating in a clockwise direction about the pin 634 in the view depicted, such that the VB inlet 626 is no longer exposed to the working gas flow path 537.

The variable bleed valve 630 may be moved between the fully deployed position (shown) whereby the variable bleed duct 624 extracts a maximum amount of airflow from the working gas flow path 537, the fully stowed position whereby the variable bleed valve 630 extracts substantially no airflow from the working gas flow path 537 (i.e., less than 5% of the maximum amount of airflow extracted), and any suitable position therebetween (one or more partially deployed positions).

The airflow from the variable bleed duct 624 may be provided to the cooling passage 610 from the VB outlet 628 in any suitable manner. For example, referring briefly to FIG. 14, it will be appreciated that in certain exemplary embodiments, the VB outlet 628 forms at least in part an ejector 636 with the cooling passage 610. In particular, for the embodiment of FIG. 4, the VB outlet 628 includes a fluid nozzle 638 configured to provide a relatively high pressure fluid flow. Further, the cooling passage 610 includes a nozzle portion 640 that includes a converging inlet nozzle 642, a diffuser throat 644, and a diverging outlet diffuser 646 arranged in serial order, with the fluid nozzle 638 of the VB outlet 628 oriented to provide the relatively high pressure fluid into the converging inlet nozzle 642. As will be appreciated, providing the high pressure fluid flow through the fluid nozzle 638 with the nozzle portion 640 located downstream, may urge a relatively low pressure fluid flow therethrough to increase the amount of airflow through the cooling passage 610.

Moreover, it should be appreciated from the description herein and the Figures, that the variable bleed duct 624 having the VB inlet 626 and the VB outlet 628 may be a first variable bleed duct 624 of a plurality of variable bleed ducts 624 of the variable bleed assembly 622. For example, referring briefly to FIG. 15, a schematic, cross-sectional view is provided showing the variable bleed assembly 622 and the cooling passage 610 described above with reference to FIG. 13. As noted, the cooling passage 610 is an annular cooling passage. Further, the variable bleed assembly 622 includes the plurality of variable bleed ducts 624 spaced along the circumferential direction C of the gas turbine engine 510. Each of the variable bleed ducts 624 generally extends between the respective VB inlets 626 in airflow communication with the working gas flow path 537 (FIG. 13) and respective VB outlets 628 in airflow communication with the cooling passage 610. Each of the plurality of variable bleed ducts 624 depicted in FIG. 15 may be configured in a similar manner as the exemplary variable bleed duct 624 described above with reference to FIGS. 13 and 14.

Referring now back to FIG. 13, the gas turbine engine 510 further includes a controller 650 operably coupled to the variable bleed assembly 622, and one or more sensors 652. The one or more sensors 652 may be configured to sense data indicative of an operating condition of the gas turbine engine 510. For example, the one or more sensors 652 generally includes a bypass passage sensor 652A (e.g., configured to sense one or more of a pressure, a temperature, or an airflow rate of airflow through the bypass passage 556), an accessory system sensor 652B (e.g., configured to sense data indicative of a condition of the accessory system 608), a sensor 652C (e.g., configured to sense data indicative of an operating condition of the core turbine engine, such as a rotational speed sensor, a temperature sensor, a pressure sensor, etc.).

As noted, the exemplary controller 650 depicted in FIG. 13 is configured to receive the data sensed from the one or more sensors (sensors 652A, 652B, 652C) for the embodiment shown) and, e.g., may make control decisions for the variable bleed assembly 622 based on the received data.

In one or more exemplary embodiments, the controller 650 depicted in FIG. 13 may be a stand-alone controller 650 for the variable bleed assembly 622, or alternatively, may be integrated into one or more of a controller for the gas turbine engine 510 with which the variable bleed assembly 622 is integrated, a controller for an aircraft including the gas turbine engine 510 with which the variable bleed assembly 622 is integrated, etc.

Referring particularly to the operation of the controller 650, in at least certain embodiments, the controller 650 can include one or more computing device(s) 654. The computing device(s) 654 can include one or more processor(s) 654A and one or more memory device(s) 654B. The one or more processor(s) 654A can include any suitable processing device, such as a microprocessor, microcontroller, integrated circuit, logic device, and/or other suitable processing device. The one or more memory device(s) 654B can include one or more computer-readable media, including, but not limited to, non-transitory computer-readable media, RAM, ROM, hard drives, flash drives, and/or other memory devices.

The one or more memory device(s) 654B can store information accessible by the one or more processor(s) 654A, including computer-readable instructions 654C that can be executed by the one or more processor(s) 654A. The instructions 654C can be any set of instructions that when executed by the one or more processor(s) 654A, cause the one or more processor(s) 654A to perform operations. In some embodiments, the instructions 654C can be executed by the one or more processor(s) 654A to cause the one or more processor(s) 654A to perform operations, such as any of the operations and functions for which the controller 650 and/or the computing device(s) 654 are configured, the operations for operating a variable bleed assembly 622 (e.g., method 700), as described herein, and/or any other operations or functions of the one or more computing device(s) 654. The instructions 654C can be software written in any suitable programming language or can be implemented in hardware. Additionally, and/or alternatively, the instructions 654C can be executed in logically and/or virtually separate threads on the one or more processor(s) 654A. The one or more memory device(s) 654B can further store data 654D that can be accessed by the one or more processor(s) 654A. For example, the data 654D can include data indicative of power flows, data indicative of engine/aircraft operating conditions, and/or any other data and/or information described herein.

The computing device(s) 654 can also include a network interface 654E used to communicate, for example, with the other components of the variable bleed assembly 622, the gas turbine engine 510 incorporating variable bleed assembly 622, the aircraft incorporating the gas turbine engine 510, etc. For example, in the embodiment depicted, as noted above, the gas turbine engine 510 and/or variable bleed assembly 622 includes one or more sensors for sensing data indicative of one or more parameters of the gas turbine engine, the variable bleed assembly 622, the cooling passage 610, the accessory system(s) 608, or a combination thereof. The controller 650 of the variable bleed assembly 622 is operably coupled to the one or more sensors through, e.g., the network interface 654E, such that the controller 650 may receive data indicative of various operating parameters sensed by the one or more sensors during operation. Further, for the embodiment shown the controller 650 is operably coupled to, e.g., actuator 632. In such a manner, the controller 650 may be configured to vary an amount of airflow through the variable bleed assembly 622 and into the cooling passage 610 in response to, e.g., the data sensed by the one or more sensors.

The network interface 654E can include any suitable components for interfacing with one or more network(s), including for example, transmitters, receivers, ports, controllers, antennas, and/or other suitable components.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

For the embodiment depicted, the controller 650 is configured to actuate the variable bleed valve 630 to increase or decrease the amount of airflow through the variable bleed duct 624. In certain exemplary aspects, the controller 650 may further be configured to receive data indicative of an operating condition of the gas turbine engine 510 (e.g., sensed data from the one or more sensors 652). In certain exemplary aspects, the controller 650 may actuate the variable bleed valve 630 to increase or decrease the amount of airflow through the variable bleed duct 624 in response to the data indicative of the operating condition.

For example, in response is to receiving data indicative of an operating condition whereby a relatively high amount of cooling may be needed, the controller 650 may be configured to actuate the variable bleed valve 630 to increase the amount of airflow through the variable bleed duct 624 (e.g., move the variable bleed valve 630 to a fully deployed position) to increase the amount of airflow through the annular cooling passage 610. By contrast, in response to receiving data indicative of an operating condition whereby a relatively low amount of cooling may be needed, the controller 650 may be configured to actuate the variable bleed valve 630 to decrease the amount of airflow through the variable bleed duct 624 (e.g., move the variable bleed valve 630 to a fully stowed position) to decrease the amount of airflow through the annular cooling passage 610.

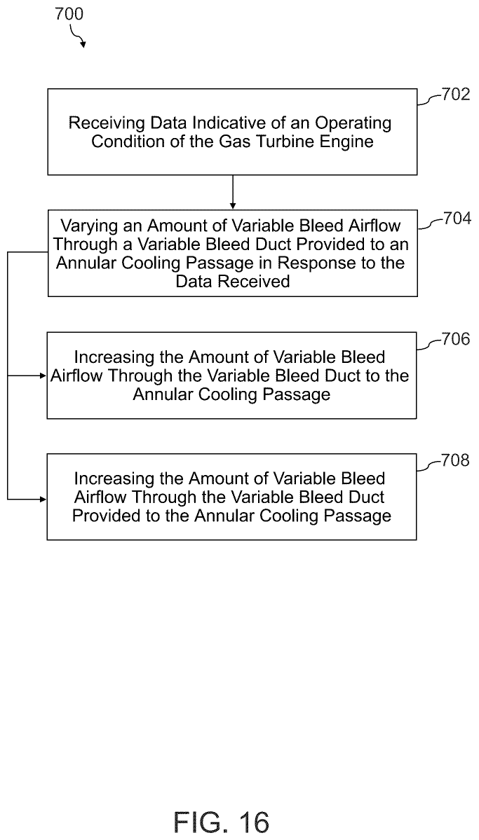

Referring now to FIG. 16, a method 700 of operating a gas turbine engine 510 in accordance with an exemplary aspect of the present disclosure is provided. The method 700 may generally be utilized with one or more of the exemplary gas turbine engines 510 described above with reference to FIGS. 7 through 15. Alternatively, the exemplary method 700 may be utilized with any other suitable gas turbine engine 510.

The method 700 generally includes at (702) receiving data indicative of an operating condition of the gas turbine engine, and at (704) varying an amount of variable bleed airflow through a variable bleed duct provided to an annular cooling passage in response to the data received at (702). The annular cooling passage extends between a CP inlet in airflow communication with a working gas flowpath of the core turbine engine and a CP outlet in airflow communication with a bypass passage of the gas turbine engine.

In certain exemplary aspects of the present disclosure, the operating condition is a low fan power operating condition. For example, the low fan power operating condition may be a ground idle operating condition or a flight idle descent operating condition. With such an exemplary aspect, varying the amount of variable bleed airflow through the variable bleed duct provided to the annular cooling passage at (704) may include at (706) increasing the amount of variable bleed airflow through the variable bleed duct provided to the annular cooling passage.

In certain exemplary aspects of the present disclosure, the operating condition is indicative of an ambient temperature. For example, the data received may be indicative of the ambient temperature being above a predetermined threshold. With such an exemplary aspect, varying the amount of variable bleed airflow through the variable bleed duct provided to the annular cooling passage at (704) may include at (708) increasing the amount of variable bleed airflow through the variable bleed duct provided to the annular cooling passage.

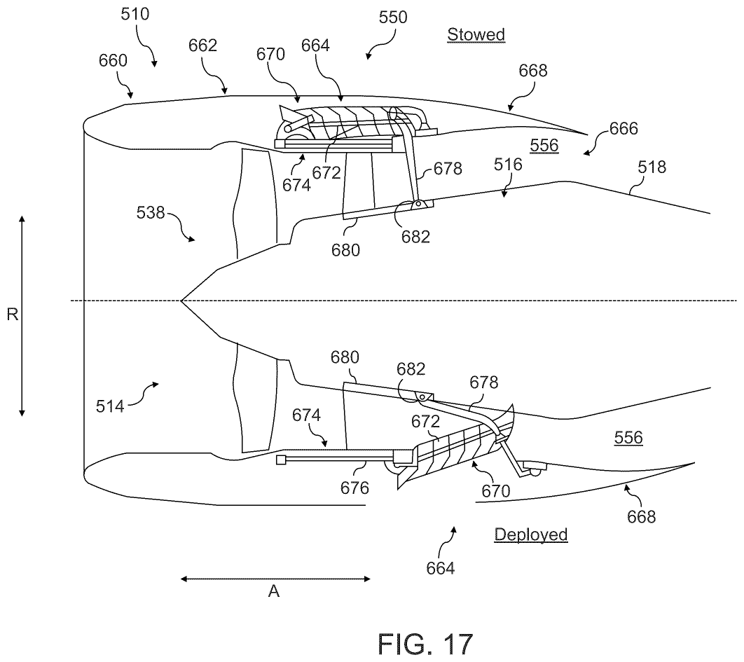

Referring now to FIG. 17, a gas turbine engine 510 in accordance with another exemplary aspect of the present disclosure is provided. The exemplary gas turbine engine 510 of FIG. 17 may be configured in a similar manner as exemplary gas turbine engine 510 described above with reference to FIG. 7. For example, the exemplary gas turbine engine 510 of FIG. 17 generally includes a fan section 514 having a fan 538, a core turbine engine 516 (depicted schematically), and an outer nacelle 550.

For the embodiment depicted, the outer nacelle 550 generally includes an inlet assembly 660 and a fan cowl 662, and the gas turbine engine 510 further includes a thrust reverser assembly 664 at least partially integrated into the outer nacelle 550. A top half of the exemplary gas turbine engine 510 in FIG. 17 is depicted with the thrust reverser assembly 664 in a stowed configuration, and a bottom half of the exemplary gas turbine engine 510 of FIG. 17 is depicted with the thrust reverser assembly 664 in a deployed configuration.

The inlet assembly 660 is positioned at a forward end of the outer nacelle 550 and the fan cowl 662 is positioned aft of the inlet assembly 660 and at least partially surrounds the fan 538. The thrust reverser assembly 664 may, in turn, be positioned at least partially or substantially completely within the fan cowl 662 when in the stowed configuration. As is depicted, an outer casing 518 of the core turbine engine 516 defines a radially inward boundary of a bypass passage 556 and the outer nacelle 550 defines a radially outward boundary of the bypass passage 556. Bypass air of the gas turbine engine 510 passes through the bypass passage 556 and exits through a fan exit nozzle 666 during certain operations.

The thrust reverser assembly 664 of FIG. 17 may include a translating cowl (transcowl) 668 slidably mounted to the fan cowl 662, and a cascade assembly 670. The transcowl 668 is located aft of the fan cowl 662 and circumscribes an outer casing 518 of the core turbine engine 516. When in the deployed configuration, the cascade assembly 670 is also located at least partially aft of the fan cowl 662 and circumscribes the core turbine engine 516. By contrast, when in the stowed configuration the cascade assembly 670 is stowed substantially completely within the fan cowl 662.

As shown in FIG. 17, the cascade assembly 670 depicted is formed of and includes a plurality of individual cascade segments 672 that are circumferentially spaced around a circumference of the outer nacelle 550. As is evident from FIG. 17, the cascade segments 672 of the cascade assembly 670 may be adapted to deploy from an axially stowed configuration, shown in the upper half of FIG. 17, to an axially deployed configuration shown in the lower half of FIG. 17. For the embodiment depicted, the transcowl 668 and cascade assembly 670 are adapted to be translated in unison in an aft direction of the gas turbine engine 510, generally along the axial direction A, when the thrust reverser assembly 664 is moved from the stowed configuration to the deployed configuration (i.e., is deployed). More particularly, to deploy the cascade assembly 670 into the bypass passage 556, the transcowl 668 is moved aft from the fan cowl 662 generally along the axial direction A and the cascade assembly 670 is translated and pivoted, causing a flow of bypass air within the bypass passage 556 to be diverted through the deployed cascade assembly 670 to provide a thrust reversal effect.

In order to facilitate the above movement of the thrust reverser assembly 664, the thrust reverser assembly 664 includes one or more actuation assemblies 674. The actuation assemblies 674 are configured to move the thrust reverser assembly 664 from the stowed configuration to the deployed configuration. The actuation assemblies 674 can be of any suitable type and can be driven by, e.g., pneumatic, hydraulic, or electric motors. Additionally, the cascade segments 672 are depicted as coupled to a fixed structure of the outer nacelle 550 with guided connections 676. Further, FIG. 17 represents the cascade segments 672 as pivotally coupled to the outer casing 518 of the core turbine engine 516 with drag links 678, and represent the transcowl 668 as pivotally coupled to the cascade segments 672 through drag links 678 for translation therewith.

More specifically, for the embodiment shown, the thrust reverser assembly 664 further includes an inner thrust reverser support 680 positioned on, coupled to, or integrated with the core turbine engine 516. The exemplary inner thrust reverser support 680 depicted generally includes a plurality of thrust reverser link attachments 682 arranged along the circumferential direction C of the gas turbine engine 510. For the embodiment shown, the drag links 678 are attachable to the plurality of thrust reverser link attachments 682, such that the inner thrust reverser support 680 may provide axial and radial support for the cascade assembly 670 through the plurality of drag links 678.

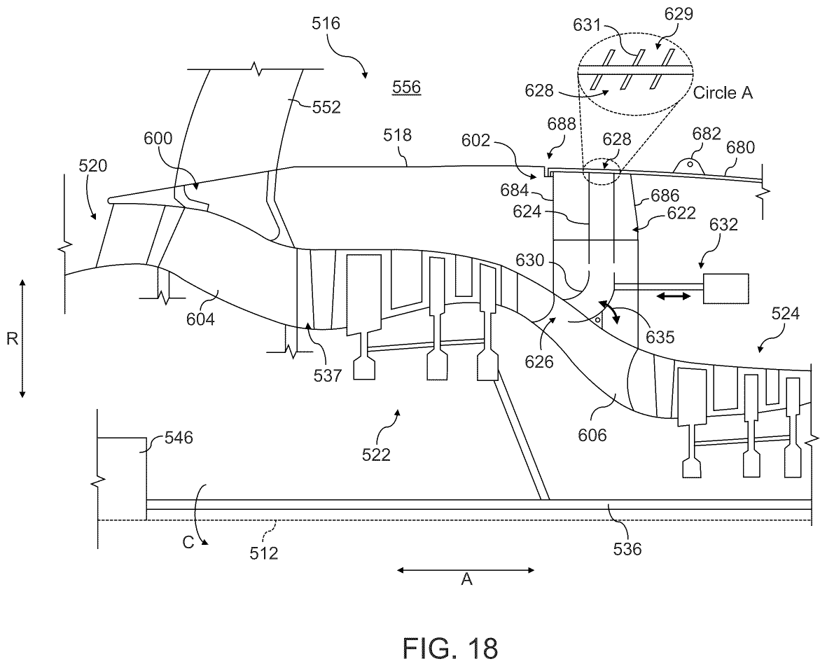

Referring now to FIG. 18, a close-up, schematic view is depicted of a portion of the exemplary gas turbine engine 510 described above with reference to FIG. 17. In particular, the view of FIG. 18 depicts a close-up of the core turbine engine 516 of FIG. 7. The core turbine engine 516 generally includes a compressor section having an LP compressor 522 and an HP compressor 524, defining at least in part a working gas flowpath 537. The core turbine engine 516 further defines an annular inlet 520 to the working gas flowpath 537. Further, for the embodiment depicted, the core turbine engine 516 includes a compressor forward frame 600 and a compressor mid-frame 602. The compressor forward frame 600 includes a strut 604 extending through the working gas flowpath 537 at a location upstream of the LP compressor 522 and downstream of the annular inlet 520. Similarly, the compressor mid-frame 602 includes a strut 606 extending through the working gas flowpath 537 at a location downstream of the LP compressor 522 and upstream of the HP compressor 524. Moreover, in the embodiment depicted the compressor mid-frame 602 generally includes a forward member 684 and an aft member 686 spaced apart from one another along an axial direction A of the gas turbine engine 510.

The compressor forward frame 600 and the compressor mid-frame 602 may provide structural support to various components of the gas turbine engine 510.

Moreover, the exemplary gas turbine engine 510 depicted schematically in FIG. 18 further includes a variable bleed assembly 622 and the thrust reverser assembly 664, with the thrust reverser assembly 664 including the inner thrust reverser support 680. The variable bleed assembly 622 generally includes a variable bleed duct 624 extending between a VB inlet 626 and a VB outlet 628. The VB inlet 626 is in airflow communication with the working gas flowpath 537 at a location aligned with the compressor mid-frame 602. Moreover, for the embodiment depicted, the VB outlet 628 is in airflow communication with the bypass passage 556 at a location aft of the forward member 684 of the compressor mid-frame 602, and forward of the aft member 686 of the compressor mid-frame 602.

Further, for the embodiment depicted, the inner thrust reverser support 680 includes a forward interface 688 coupled to the forward member 684 of the compressor mid-frame 602. The forward interface 688 is configured to provide axial support for the inner thrust reverser support 680, as will be explained in more detail below. In such a manner, the inner thrust reverser support 680 extends from the forward member 684 of the compressor mid-frame 602, past the aft member 686 of the compressor mid-frame 602. With such a configuration, it will be appreciated that the VB outlet 628 is in airflow communication with the bypass passage 556 through the inner thrust reverser support 680. In at least certain exemplary embodiments, as is depicted in the callout Circle A in FIG. 18, the variable bleed assembly 622 may additionally include a cover 629 at the VB outlet 628 with one or more features to turn an airflow from the VB outlet 628 axially. The cover 629 depicted includes a plurality of louvers 631 that may be fixed or rotatable to provide such functionality.

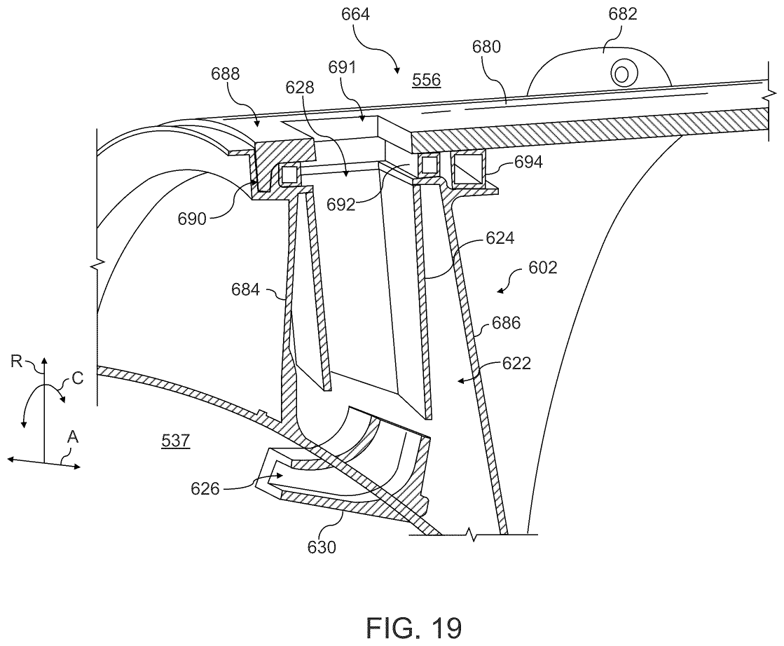

More specifically, referring now to FIG. 19, a cross-sectional, isometric view is provided of the compressor mid-frame 602, variable bleed assembly 622, and inner thrust reverser support 680 of FIG. 18.

As noted above, the inner thrust reverser support 680 includes the forward interface 688 coupled to the forward member 684 of the compressor mid-frame 602. More specifically, for the embodiment depicted, the forward interface 688 includes a radial member (not separately labeled) extending inwardly along a radial direction R of the gas turbine engine 510. The forward member 684 of the compressor mid-frame 602 defines a circumferential groove 690 extending along the circumferential direction C in defining a radial depth. The radial member of the forward interface 688 is positioned within the circumferential groove 690 to couple the inner thrust reverser support 680 to the compressor mid-frame 602. As will be appreciated from the view of FIG. 19, the inner thrust reverser support 680 defines an annular shape, and extends substantially 360° (i.e., at least about 90%) around the core turbine engine 516.

As is also briefly mentioned above, the VB outlet 628 of the variable bleed duct 624 is in airflow communication with the bypass passage 556 through the inner thrust reverser support 680, and more specifically through an opening 691 defined in the inner thrust reverser support 680. Although not depicted for clarity in FIG. 19, the cover 629 described above with reference to FIG. 18 may be positioned in or across the opening 691 defined in the inner thrust reverser support 680.

Referring still to FIG. 19, in the embodiment depicted, the thrust reverser assembly 664 includes a seal 692 positioned between the inner thrust reverser support 680 and one or both of the compressor mid-frame 602 and the variable bleed duct 624. In particular, for the embodiment depicted, the seal 692 is positioned between the inner thrust reverser support 680 and the compressor mid-frame 602. The seal 692 may prevent undesirable airflow leakage into the compressor mid-frame 602, and/or aft the compressor mid-frame 602, which may urge the inner thrust reverser support 680 out of alignment (e.g., the radial member out of the circumferential groove 690).

Briefly, it will further be appreciated that for the embodiment depicted, the thrust core turbine engine 516 further includes a fire seal 694 positioned between an extension of the aft member 686 of the compressor mid-frame 602 and the inner thrust reverser support 680. The fire seal 694 is an annular seal, extending 360° in the circumferential direction C.

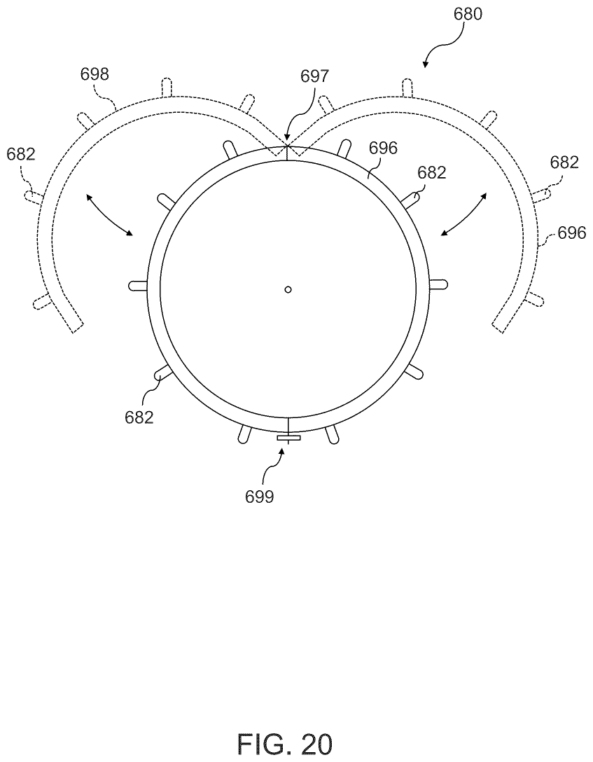

It will be appreciated that in order to facilitate assembly of the inner thrust reverser support 680, the inner thrust reverser support 680 may be configured as a two-piece assembly. For example, referring briefly to FIG. 20, a schematic view is provided of the inner thrust reverser support 680, as viewed along an axial direction A of the gas turbine engine 510 with which the inner thrust reverser support 680 may be installed. As will be appreciated, the inner thrust reverser support 680 includes a first member 696 and a second member 698. The first member 696 and the second member 698 together extend substantially 360° when coupled together. In order to install, e.g., the radial member of the inner thrust reverser support 680 into the circumferential groove 690 of the forward member 684 of the compressor mid-frame 602 (see FIG. 19), the first member 696 and the second member 698 of the inner thrust reverser support 680 may be individually installed (as is depicted in phantom in FIG. 20).

In such a manner, it will be appreciated that the first member 696 and the second member 698 may together define a hinged connection 697 (i.e., any mechanical connection that allows for the first member to pivot relative to the second member, such as a pinned connection) on one side and a releasable mechanical connection 699 (i.e., any mechanical connection that allows for a release without damaging the connection during a normal course, such as a bolted connection, a ratcheted connection, a latched connection, or the like) on an opposite side.

It will be appreciated, however, that in other exemplary embodiments, the forward interface 688 (FIG. 19) of the inner thrust reverser support 680 may be configured in any other suitable manner. For example, in other embodiments, the forward interface 688 may utilize any other suitable mechanical connection, such as, e.g., bolts, screws, rivets, welding, complementary geometries (e.g., dovetails), etc.

Further, it will be appreciated that although the exemplary variable bleed assembly 622 depicted in FIGS. 17 and 18 includes a single variable bleed duct 624 extending between a single VB inlet 626 and a single VB outlet 628, in other exemplary embodiments, the variable bleed assembly 622 may include a plurality of variable bleed ducts 624 spaced along a circumferential direction C (each with a respective VB inlet 626). The plurality of variable bleed ducts 624 may be in fluid communication with a plenum, with the plenum defining the VB outlet 628, and a seal 692 around the VB outlet 628. Alternatively, the plurality of variable bleed ducts 624 may each define a separate VB outlet 628, and the seal 692 may extend around the plurality of VB outlets 628.

Further, still, it will be appreciated that although exemplary VB outlet 628 of the exemplary variable bleed duct 624 of FIGS. 18 and 19 extends through the inner thrust reverser support 680, in other exemplary embodiments, any other suitable configuration may be provided.

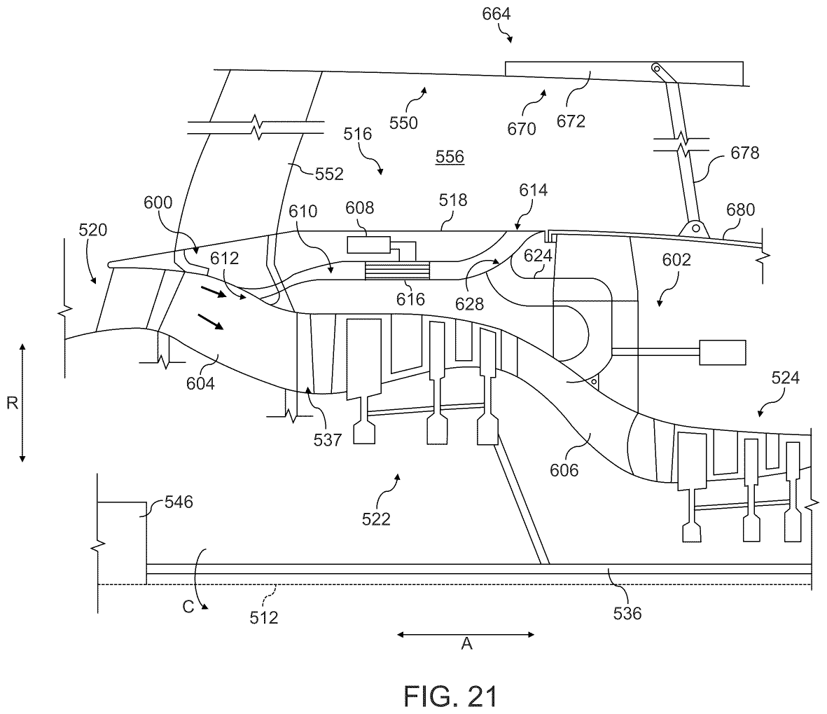

For example, referring now to FIG. 21, a close-up, schematic view of a gas turbine engine 510 in accordance with another exemplary aspect of the present disclosure is provided. The exemplary gas turbine engine 510 depicted in FIG. 21 may be configured in a similar manner as exemplary gas turbine engine 510 described above with reference to FIGS. 18 and 19. The same or similar numbers may refer to the same or similar part.

For example, the exemplary gas turbine engine 510 depicted in FIG. 21 generally includes a gas turbine engine 510 having a core turbine engine 516 and an outer nacelle 550, and defines a bypass passage 556 therebetween. The gas turbine engine 510 further includes a thrust reverser assembly 664 having an inner thrust reverser support 680 coupled to or formed integrally with the core turbine engine 516 and including a forward interface 688 coupled to a forward member 684 of a compressor mid-frame 602 of the core turbine engine 516. The inner thrust reverser support 680 includes a plurality of thrust reverser link attachments 682. The thrust reverser assembly 664 further includes a cascade assembly 670 having a plurality of cascade segments 672, and a plurality of drag links 678 extending from the cascade assembly 670 and attached to a plurality of thrust reverser link attachments 682 on the inner thrust reverser support 680.

Further, the exemplary core turbine engine 516 generally includes a variable bleed assembly 622 having a variable bleed duct 624 extending between a VB inlet 626 and a VB outlet 628. However, for the embodiment of FIG. 21, the VB outlet 628 is not in airflow communication with the bypass passage 556 through the inner thrust reverser support 680. Instead, for the embodiment of FIG. 21, the core turbine engine 516 defines a cooling passage 610 extending between a CP inlet 612 and a CP outlet 614. The CP inlet 612 is in airflow communication with a working gas flowpath 537 of the core turbine engine 516 at a location upstream of a compressor section of the core turbine engine 516, and the CP outlet 614 is in airflow communication with the bypass passage 556 of the gas turbine engine 510 defined between the outer nacelle 550 and the core turbine engine 516. The VB outlet 628 is in airflow communication with the cooling passage 610. More specifically, for the embodiment shown, the variable bleed duct 624 of the variable bleed assembly 622 extends forward of the forward member 684 of the compressor mid-frame 602 to the cooling passage 610. In such a manner, it will be appreciated that the VB outlet 628 is in airflow communication with the bypass passage 556 through the cooling passage 610 and CP outlet 614 of the cooling passage 610, which is positioned at a location forward of the forward interface 688 of the thrust reverser support.

Moreover, it will be appreciated that although for the embodiments of FIGS. 17 through 21, an inner thrust reverser support 680 is depicted and described as being attached to the forward member 684 of the compressor mid-frame 602, in other embodiments, any other suitable hinged cowl assembly extending at least partially around a compressor section of a turbomachine or a core turbine engine may be provided, with the hinged cowl assembly including a forward interface coupled to the forward member of the compressor mid-frame.

As with the embodiments described above, the hinged cowl assembly may include a first member and a second member, with the first member and the second member together extending substantially 360° when coupled together (similar to the embodiment depicted in FIG. 20). Further, the first member and the second member may together define a hinged connection (i.e., any mechanical connection that allows for the first member to pivot relative to the second member, such as a pinned connection) and a releasable mechanically connection (i.e., any mechanical connection that allows for a release without damaging the connection during a normal course, such as a bolted connection, a ratcheted connection, a latched connection, or the like).

It will be appreciated that inclusion of an inner thrust reverser support having a forward interface coupled to a forward member of a compressor mid-frame may allow for the inner thrust reverser support to be moved forward along an axial direction. Such may generally allow for more desirable aerodynamic lines of an outer casing encompassing turbomachinery of a core turbine engine of the gas turbine engine, which may allow for a shorter and lighter gas turbine engine. In particular, when incorporated into a gas turbine engine including a reduction gearbox, such may allow for aerodynamic lines of the outer casing to more optimally define an outlet nozzle for a bypass passage in a shorter axial footprint, given a potential reduction in turbine stage enabled by inclusion of the reduction gearbox, allowing for the shorter and lighter gas turbine engine.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

A turbomachine for an aircraft, comprising: an annular casing; and a fan disposed inside the annular casing and mounted for rotation about an axial centerline, the fan including fan blades that extend radially outwardly toward the annular casing; wherein the fan includes an average fan chord width of the fan blades (“c”), a diameter of the fan (“D”), a fan pressure ratio (“FPR”), and a redline corrected fan tip Mach number (“M_{tip,c}^{(RL)}”) according to a First Performance Factor; wherein

$$FPF = [ \frac{c}{0.15 \cdot D} ] / [ [ \frac{\sqrt{FPR - 1}}{\sqrt{0.4}} ] / {M}_{tip , c}^{( RL )} ] - 1.23 , and wherein$$

$${m}_{1} \cdot [ {M}_{tip , c}^{( RL )} - 1.1 ] + 6 > FPF > {m}_{1} \cdot [ {M}_{tip , c}^{( RL )} - 1.1 ] + Δ {y}_{1} , and wherein 0 < Δ {y}_{1} < 6.$$

The turbomachine of one or more of these clauses wherein M_{tip,c}^{(RL)} is within a range equal to or greater than 0.45 and equal to or less than 1.34.

The turbomachine of one or more of these clauses wherein M_{tip,c}^{(RL)} is within a range equal to or greater than 0.45 and equal to or less than 1.12.

The turbomachine of one or more of these clauses wherein m₁ is equal to 0.87 when M_{tip,c}^{(RL)} is greater than or equal to 1.1.

The turbomachine of one or more of these clauses wherein m₁ is equal to 1.0 when M_{tip,c}^{(RL)} is greater than or equal to 1.1.

The turbomachine of one or more of these clauses wherein m₁ is equal to 2.5 when M_{tip,c}^{(RL)} is less than 1.1.

The turbomachine of one or more of these clauses wherein m₁ is equal to 3.34 when M_{tip,c}^{(RL)} is less than 1.1.

The turbomachine of one or more of these clauses wherein Δy₁ is equal to or greater than 0.0125 and less than 6.

The turbomachine of one or more of these clauses wherein Δy₁ is equal to or greater than 0.04 and less than 6.

The turbomachine of one or more of these clauses wherein Δy₁ is equal to or greater than 0.07 and less than 6.

The turbomachine of one or more of these clauses wherein Δy₁ is equal to or greater than 0.1 and less than 6.

The turbomachine of one or more of these clauses wherein Δy₁ is equal to or greater than 0.2 and less than 6.

The turbomachine of one or more of these clauses wherein the turbomachine has a gear ratio within a range equal to or greater than 3.2 and equal to or less than 5.0.

The turbomachine of one or more of these clauses wherein the fan blade includes an airfoil portion made from a polymer matrix composite (PMC) material, a metallic leading edge, the ratio c/D is between 0.16 and 0.21, and the fan has between 16 and 25 fan blades.

The turbomachine of one or more of these clauses wherein ratio c/D is within a range equal to or greater than 0.1 and equal to or less than 0.3.

The turbomachine of one or more of these clauses wherein ratio c/D is within a range equal to or greater than 0.15 and equal to or less than 0.21.

The turbomachine of one or more of these clauses wherein ratio c/D is equal to or greater than 0.1.

The turbomachine of one or more of these clauses wherein ratio c/D is equal to or less than 0.3.

The turbomachine of one or more of these clauses wherein FPR is within a range equal to or greater than 1.2 and equal to or less than 1.5.

The turbomachine of one or more of these clauses wherein FPR is within a range equal to or greater than 1.3 and equal to or less than 1.45.

The turbomachine of one or more of these clauses wherein FPR is equal to or greater than 1.2.

The turbomachine of one or more of these clauses wherein FPR is equal to or greater than 1.3.

The turbomachine of one or more of these clauses wherein FPR is equal to or less than 1.5.

The turbomachine of one or more of these clauses wherein FPR is equal to or less than 1.45.

The turbomachine of one or more of these clauses wherein U_{c(tip)} is within a range equal to or greater than 500 ft/sec and equal to or less than 1,500 ft/sec.

The turbomachine of one or more of these clauses wherein U_{c(tip)} is within a range equal to or greater than 500 ft/sec and equal to or less than 1,250 ft/sec.

A turbomachine comprising: an annular casing; and a fan disposed inside the annular casing and mounted for rotation about an axial centerline, the fan including fan blades that extend radially outwardly toward the annular casing; wherein the fan includes a fan hub-to-tip ratio (“HTR”), a fan blade count (“BC”), a fan pressure ratio (“FPR”), and a redline corrected redline fan tip Mach number (“M_{tip,c}^{RL)}”) according to a Second Performance Factor (“SPF”),

$$SPF = \sqrt{\frac{π}{4} ( 1 - {HTR}^{2} ) / ( \frac{BC}{20} )} / ( \frac{\sqrt{FPR - 1}}{\sqrt{0.4}} ) / {M}_{tip , c}^{( RL )} - 0.97 , wherein {m}_{2} \cdot [ {M}_{tip , c}^{( RL )} - 1.1 ] + 1.5 > SPF > {m}_{2} \cdot [ {M}_{tip , c}^{( RL )} - 1.1 ] + Δ {y}_{2} , and wherein 0 < Δ {y}_{2} < 1.5 .$$

The turbomachine of one or more of these clauses wherein Ay₂ is equal to or greater than 0.0075 and less than 1.5.

The turbomachine of one or more of these clauses wherein Ay₂ is equal to or greater than 0.01 and less than 1.5.

The turbomachine of one or more of these clauses wherein Ay₂ is equal to or greater than 0.02 and less than 1.5.

The turbomachine of one or more of these clauses wherein Ay₂ is equal to or greater than 0.024 and less than 1.5.

The turbomachine of one or more of these clauses wherein Ay₂ is equal to or greater than 0.037 and less than 1.5.

The turbomachine of one or more of these clauses wherein Ay₂ is equal to or greater than 0.04 and less than 1.5.

The turbomachine of one or more of these clauses wherein Ay₂ is equal to or greater than 0.06 and less than 1.5.

The turbomachine of one or more of these clauses wherein m₂ is equal to 0.41 when M_{tip,c}^{(RL)} is greater than or equal to 1.1.

The turbomachine of one or more of these clauses wherein m₂ is equal to 0.55 when M_{tip,c}^{(RL)} is less than 1.1.

The turbomachine of one or more of these clauses wherein HTR is within a range equal to or greater than 0.1 and equal to or less than 0.5.

The turbomachine of one or more of these clauses wherein HTR is within a range equal to or greater than 0.2 and equal to or less than 0.275.

The turbomachine of one or more of these clauses wherein HTR is within a range equal to or greater than 0.2 and equal to or less than 0.25.

The turbomachine of one or more of these clauses wherein HTR is equal to or greater than 0.1.

The turbomachine of one or more of these clauses wherein HTR is equal to or less than 0.5.

The turbomachine of one or more of these clauses wherein BC is within a range equal to or greater than 10 and equal to or less than 18.

The turbomachine of one or more of these clauses wherein FPR is within a range equal to or greater than 1.2 and equal to or less than 1.5.

The turbomachine of one or more of these clauses wherein FPR is within a range equal to or greater than 1.3 and equal to or less than 1.45.

A method of assembly, comprising: mounting a fan inside an annular casing for rotation about an axial centerline, the fan including fan blades that extend radially outwardly toward the annular casing; wherein the fan includes an average fan chord width of the fan blades (“c”), a diameter of the fan (“D”), a fan pressure ratio (“FPR”), and a redline corrected fan tip redline Mach number (“M_{tip,c}^{(RL)}”) according to a First Performance Factor (“FPF”), wherein:

$$FPF = [ \frac{c}{0.15 \cdot D} ] / [ [ \frac{\sqrt{FPR - 1}}{\sqrt{0.4}} ] / {M}_{tip , c}^{( RL )} ] - 1.23 ;$$

$${m}_{1} \cdot [ {M}_{tip , c}^{( RL )} - 1.1 ] + 6 > FPF > {m}_{1} \cdot [ {M}_{tip , c}^{( RL )} - 1.1 ] + Δ {y}_{1} ; and$$

$$0 < Δ {y}_{1} < 6 ;$$

or wherein the fan includes a fan hub-to-tip ratio (“HTR”), a fan blade count (“BC”), FPR, and M_{tip,c}^{(RL)} according to a Second Performance Factor (“SPF”), wherein:

$$S P F = \frac{\sqrt{\frac{π}{4} ( 1 - H T {R}^{2} ) / ( \frac{B C}{20} )}}{( \frac{\sqrt{F P R - 1}}{\sqrt{0.4}} ) / {M}_{tip , c}^{( RL )}} - 0.97 ;$$

$${m}_{2} \cdot [ {M}_{tip , c}^{( RL )} - 1.1 ] + 1.5 > S P F > {m}_{2} \cdot [ {M}_{tip , c}^{( RL )} - 1.1 ] + Δ {y}_{2} ; and$$

$$0 < Δ {y}_{2} < 1.5 .$$

A turbomachine for an aircraft, comprising: an annular casing; and a fan disposed inside the annular casing and mounted for rotation about an axial centerline, the fan including fan blades that extend radially outwardly toward the annular casing; wherein the fan includes an average fan chord width of the fan blades (“c”), a diameter of the fan (“D”), a fan pressure ratio (“FPR”), and a redline corrected fan tip Mach number (“M_{tip,c}^{(RL)}”), according to a First Performance Factor; wherein

$$F P F = [ \frac{c}{0.15 \cdot D} ] / [ [ \frac{\sqrt{F P R - 1}}{\sqrt{0.4}} ] / {M}_{tip , c}^{( R L )} ] - 1.23 , and$$

$$wherein {m}_{1} \cdot [ {M}_{tip , c}^{( R L )} - 1.1 ] + 9 \text{.14} > F P F > {m}_{2} \cdot [ {M}_{tip , c}^{( R L )} - 1.1 ] ,$$

wherein m₁ is equal to 9.43 when M_{tip,c}^{(RL)} is greater than or equal to 1.1 and is equal to 27.02 when M_{tip,c}^{(RL)} is less than 1.1, and wherein m₂ is equal to 0.87 when M_{tip,c}^{(RL)} is greater than or equal to 1.1 and is equal to 3.34 when M_{tip,c}^{(RL)} is less than 1.1.

The turbomachine of one or more of these clauses wherein FPF is within a range equal to or greater than −0.8 and equal to or less than 8.4.

The turbomachine of one or more of these clauses wherein FPF is within a range equal to or greater than 0 and equal to or less than 6.

The turbomachine of one or more of these clauses wherein FPF is within a range equal to or greater than 1 and equal to or less than 2.

The turbomachine of one or more of these clauses wherein MI is within a range equal to or greater than 0.8 and equal to or less than 1.5.

The turbomachine of one or more of these clauses wherein M (RL) is within a range equal to or greater than 0.9 and equal to or less than 1.4.

The turbomachine of one or more of these clauses wherein ratio c/D is within a range equal to or greater than 0.1 and equal to or less than 0.3.

The turbomachine of one or more of these clauses wherein FPR is within a range equal to or greater than 1.2 and equal to or less than 1.6.

The turbomachine of one or more of these clauses wherein FPR is within a range equal to or greater than 1.3 and equal to or less than 1.5.

The turbomachine of one or more of these clauses wherein FPR is within a range equal to or greater than 1.35 and equal to or less than 1.45.

The turbomachine of one or more of these clauses wherein the turbomachine has a gear ratio within a range equal to or greater than 3.2 and equal to or less than 5.0.

The turbomachine of one or more of these clauses wherein the fan blade includes an airfoil portion made from a polymer matrix composite (PMC) material, a metallic leading edge, the ratio c/D is between 0.16 and 0.21, and the fan has between 16 and 25 fan blades.

A turbomachine comprising: an annular casing; and a fan disposed inside the annular casing and mounted for rotation about an axial centerline, the fan including fan blades that extend radially outwardly toward the annular casing; wherein the fan includes a fan hub-to-tip ratio (“HTR”), a fan blade count (“BC”), a fan pressure ratio (“FPR”), and a redline corrected redline fan tip Mach number (“M_{tip,c}^{(RL)}”) according to a Second Performance Factor (“SPF”),

$$S P F = S P F = \frac{\sqrt{\frac{π}{4} ( 1 - H T {R}^{2} ) / ( \frac{B C}{20} )}}{( \frac{\sqrt{F P R - 1}}{\sqrt{0.4}} ) / {M}_{tip , c}^{( R L )}} - 0.97 ,$$

$$wherein {m}_{3} \cdot [ {M}_{tip , c}^{( R L )} - 1.1 ] + 2.52 > S P F > {m}_{4} \cdot [ {M}_{tip , c}^{( R L )} - 1.1 ]$$

wherein m₃ is equal to 3.17, and wherein m₄ is equal to 0.41 when M_{tip,c}^{(RL)} is greater than or equal to 1.1 and is equal to 0.55 when M_{tip,c}^{(RL)} is less than 1.1.

The turbomachine of one or more of these clauses wherein SPF is within a range equal to or greater than 0.087 and equal to or less than 2.4.

The turbomachine of one or more of these clauses wherein SPF is within a range equal to or greater than 1 and equal to or less than 2.

A turbomachine for an aircraft, comprising: an annular casing; and a fan disposed inside the annular casing and mounted for rotation about an axial centerline, the fan including fan blades that extend radially outwardly toward the annular casing; wherein the fan includes an average fan chord width of the fan blades (“c”), a diameter of the fan (“D”), a fan pressure ratio (“FPR”), and a redline corrected fan tip speed (“U_{c,tip})”), according to a First Performance Factor; wherein FPF=[c/D]/[\sqrt{FPR−1}/U_{c(tip)}]; and wherein 0.24*U_{c(tip)}+489>FPF>0.24*U_{c(tip)}−12+dy₁ and wherein 0<dy₁<500.

The turbomachine of one or more of these clauses wherein ratio c/D is within a range equal to or greater than 0.1 and equal to or less than 0.3.

The turbomachine of one or more of these clauses wherein ratio c/D is within a range equal to or greater than 0.15 and equal to or less than 0.21.

The turbomachine of one or more of these clauses wherein ratio c/D is equal to or greater than 0.1.

The turbomachine of one or more of these clauses wherein ratio c/D is equal to or less than 0.3.

The turbomachine of one or more of these clauses wherein FPR is within a range equal to or greater than 1.2 and equal to or less than 1.5.

The turbomachine of one or more of these clauses wherein FPR is within a range equal to or greater than 1.3 and equal to or less than 1.45.

The turbomachine of one or more of these clauses wherein FPR is equal to or greater than 1.2.

The turbomachine of one or more of these clauses wherein FPR is equal to or greater

than 1.3.

The turbomachine of one or more of these clauses wherein FPR is equal to or less than 1.5.

The turbomachine of one or more of these clauses wherein FPR is equal to or less than 1.45.

The turbomachine of one or more of these clauses wherein U_{c,tip}) is within a range equal to or greater than 500 ft/sec and equal to or less than 1,500 ft/sec.

The turbomachine of one or more of these clauses wherein U_{c,tip}) is within a range equal to or greater than 500 ft/sec and equal to or less than 1,250 ft/sec.

The turbomachine of one or more of these clauses wherein dy₁ is equal to or greater than 7.5 and equal to or less than 500.

The turbomachine of one or more of these clauses wherein dy₁ is equal to or greater than 16 and equal to or less than 500.

The turbomachine of one or more of these clauses wherein dy₁ is equal to or greater than 25 and equal to or less than 500.

A turbomachine comprising: an annular casing; and a fan disposed inside the annular casing and mounted for rotation about an axial centerline, the fan including fan blades that extend radially outwardly toward the annular casing; wherein the fan includes a fan hub-to-tip ratio (“HTR”), a fan blade count (“BC”), a fan pressure ratio (“FPR”), and a redline corrected fan tip speed (“U_{c,tip})”) according to a Second Performance Factor (“SPF”); wherein

$$S P F = \sqrt{\frac{π}{4} \cdot ( \frac{1 - H T {R}^{2}}{B C} )} / [ \frac{F P R - 1}{{U}_{c ( tip )}} ] ; and$$

$$wherein 0.15 * {U}_{c ( tip )} + 654 > S P F > 0.15 * {U}_{c ( tip )} + 153 + d {y}_{2} and$$

$$wherein 0 < d {y}_{2} < 500 .$$

The turbomachine of one or more of these clauses wherein HTR is within a range equal to or greater than 0.1 and equal to or less than 0.5.

The turbomachine of one or more of these clauses wherein HTR is within a range equal to or greater than 0.2 and equal to or less than 0.275.

The turbomachine of one or more of these clauses wherein HTR is within a range equal to or greater than 0.2 and equal to or less than 0.25.

The turbomachine of one or more of these clauses wherein HTR is equal to or greater than 0.1.

The turbomachine of one or more of these clauses wherein HTR is equal to or less than 0.5.

The turbomachine of one or more of these clauses wherein BC is within a range equal to or greater than 10 and equal to or less than 18.

The turbomachine of one or more of these clauses wherein FPR is within a range equal to or greater than 1.2 and equal to or less than 1.5.

The turbomachine of one or more of these clauses wherein FPR is within a range equal to or greater than 1.3 and equal to or less than 1.45.

The turbomachine of one or more of these clauses wherein FPR is equal to or greater than 1.2.

The turbomachine of one or more of these clauses wherein FPR is equal to or greater than 1.3.

The turbomachine of one or more of these clauses wherein FPR is equal to or less than 1.5.

The turbomachine of one or more of these clauses wherein FPR is equal to or less than 1.45.

The turbomachine of one or more of these clauses wherein U_{c,tip}) is within a range equal to or greater than 500 ft/sec and equal to or less than 1,500 ft/sec.

The turbomachine of one or more of these clauses wherein U_{c,tip}) is within a range equal to or greater than 500 ft/sec and equal to or less than 1,250 ft/sec.

The turbomachine of one or more of these clauses wherein dy₂ is equal to 5 and equal to or less than 500.

The turbomachine of one or more of these clauses wherein dy₂ is equal to 10 and equal to or less than 500.

The turbomachine of one or more of these clauses wherein dy₂ is equal to 15 and equal to or less than 500.

A method of assembly, comprising: mounting a fan inside an annular casing for rotation about an axial centerline, the fan including fan blades that extend radially outwardly toward the annular casing; wherein the fan includes an average fan chord width of the fan blades (“c”), a diameter of the fan (“D”), a fan pressure ratio (“FPR”), and a redline corrected fan tip speed (“U_{c(tip)}”) according to a First Performance Factor (“FPF”), wherein: FPF=[c/D]/[\sqrt{FPR−1}/U_{c(tip)}]; and 0.24*U_{c(tip)}+489>FPF>0.24*U_{c(tip)}−12+dy₁ and wherein 0<dy₁<500; or wherein the fan includes a fan hub-to-tip ratio (“HTR”), a fan blade count (“BC”), FPR, and U_{c(tip)} according to a Second Performance Factor (“SPF”), wherein:

$$SPF = \sqrt{\frac{π}{4} \cdot ( \frac{1 - H T {R}^{2}}{B C} )} / [ \frac{F P R - 1}{{U}_{c ( tip )}} ] ; and$$

$$0.15 * {U}_{c ( tip )} + 654 > S P F > 0.15 * {U}_{c ( tip )} + 153 + d {y}_{2} and$$

$$wherein 0 < {dy}_{2} < 500.$$

A gas turbine engine comprising: a fan assembly comprising a fan; and a turbomachine drivingly coupled to the fan and comprising a compressor section, a combustion section, and a turbine section arranged in serial flow order and defining in part a working gas flowpath, the gas turbine engine defining a bypass passage over the turbomachine; the turbomachine further comprising a heat exchanger and defining an annular cooling passage extending between an inlet and an outlet, the inlet in airflow communication with the working gas flowpath at a location upstream of the compressor section and the outlet in airflow communication with the bypass passage, the heat exchanger in thermal communication with an airflow through the cooling passage.

The gas turbine engine of any preceding clause, wherein the compressor section comprises a low pressure compressor and a high pressure compressor, and wherein the inlet is in airflow communication with the working gas flowpath at a location upstream of the low pressure compressor.

The gas turbine engine of any preceding clause, wherein the low pressure compressor is located downstream of the fan and is wherein no intermediate stages of compression are located between the fan and the low pressure compressor.

The gas turbine engine of any preceding clause, wherein the fan is a single stage fan.

The gas turbine engine of any preceding clause, further comprising: an outer nacelle surrounding the fan and at least a portion of the turbomachine, wherein the bypass passage is defined between the turbomachine and the outer nacelle.

The gas turbine engine of any preceding clause, wherein the turbomachine defines a turbomachine inlet to the working gas flowpath, wherein the turbomachine inlet is located immediately downstream of the fan, and wherein the fan is a single stage fan.

The gas turbine engine of any preceding clause, wherein the gas turbine engine defines an axial direction, and wherein the outlet is aligned with the compressor section along the axial direction.

The gas turbine engine of any preceding clause, wherein the gas turbine engine defines a circumferential direction, and wherein the heat exchanger is a first heat exchanger of a plurality of heat exchangers arranged along the circumferential direction within the annular cooling passage.

The gas turbine engine of any preceding clause, wherein the turbomachine comprises a compressor mid-frame, and wherein the outlet is in airflow communication with the bypass passage at a location forward of the compressor mid-frame.

The gas turbine engine of any preceding clause, wherein the gas turbine engine defines an axial direction, wherein the turbomachine comprises a compressor forward frame, and wherein the inlet is aligned with the compressor forward frame along the axial direction.

The gas turbine engine of any preceding clause, wherein the turbomachine includes a means for urging the airflow through the cooling passage.

The gas turbine engine of any preceding clause, wherein the turbomachine comprises an inlet scoop extending into the working gas flowpath to divert an airflow through the working gas flowpath and into the inlet of the cooling passage.

The gas turbine engine of any preceding clause, wherein the turbomachine comprises a hood extending over the outlet of the cooling passage, wherein the hood extends into the bypass passage to reduce a static pressure at the outlet of the cooling passage.

The gas turbine engine of any preceding clause, wherein the turbomachine comprises an ejector positioned in airflow communication with the cooling passage, wherein the ejector is in airflow communication with a high pressure air source.

The gas turbine engine of any preceding clause, wherein the turbomachine comprises a variable bleed assembly, and wherein the high pressure air source is the variable bleed assembly.

The gas turbine engine of any preceding clause, wherein during operating of the gas turbine engine at a first operating condition, the cooling passage is configured to receive between 2% and 20% of a total airflow through the working gas flowpath at a location upstream of the inlet.

The gas turbine engine of any preceding clause, wherein the first operating condition is a takeoff operating condition.

The gas turbine engine of any preceding clause, wherein during operating of the gas turbine engine at a first operating condition, the cooling passage is configured to receive between 4% and 12% of a total airflow through the working gas flowpath at a location upstream of the inlet.

The gas turbine engine of any preceding clause, wherein the gas turbine engine is a ducted turbofan engine.

The gas turbine engine of any preceding clause, further comprising: a reduction gearbox, wherein the turbomachine is drivingly coupled to the fan through the reduction gearbox.

A gas turbine engine comprising: a fan assembly comprising a fan; a turbomachine drivingly coupled to the fan and comprising a compressor section, a combustion section, and a turbine section arranged in serial flow order and defining in part a working gas flowpath, the gas turbine engine defining a bypass passage over the turbomachine, the turbomachine defining an annular cooling passage extending between a CP inlet and a CP outlet, the CP inlet in airflow communication with the working gas flowpath and the CP outlet in airflow communication with the bypass passage; and a variable bleed assembly comprising a variable bleed duct extending between a VB inlet and a VB outlet, the VB inlet in airflow communication with the working gas flowpath at a location downstream of the CP inlet and the VB outlet in airflow communication with the annular cooling passage for urging an airflow through the cooling passage.

The gas turbine engine of any preceding clause, wherein the compressor section comprises a compressor, wherein the CP inlet is in airflow communication with the working gas flowpath at a location upstream of the compressor, and wherein the VB inlet is in airflow communication with the working gas flowpath at a location downstream of the compressor.

The gas turbine engine of any preceding clause, wherein the compressor is a low pressure compressor.

The gas turbine engine of any preceding clause, wherein the compressor section further comprises a high pressure compressor, wherein the VB inlet is in airflow communication with the working gas flowpath at a location upstream of the high pressure compressor.

The gas turbine engine of any preceding clause, wherein the variable bleed assembly comprises a variable bleed valve for varying an amount of airflow through the variable bleed duct.

The gas turbine engine of any preceding clause, further comprising: a controller operably coupled to the variable bleed valve, wherein the controller is configured to actuate the variable bleed assembly to increase the amount of airflow through the variable bleed duct in response to an operating condition of the gas turbine engine to increase an amount of airflow through the annular cooling passage.

The gas turbine engine of any preceding clause, wherein the VB outlet forms at least in part an ejector.

The gas turbine engine of any preceding clause, wherein substantially all of an airflow through the variable bleed duct is provided through the VB outlet to the cooling passage.

The gas turbine engine of any preceding clause, wherein the VB outlet is a first VB outlet, and wherein the variable bleed duct further comprises a second VB outlet, wherein the second VB outlet is in direct airflow communication with the bypass passage.

The gas turbine engine of any preceding clause, wherein the turbomachine comprises a heat exchanger in thermal communication with the airflow through the cooling passage.

The gas turbine engine of any preceding clause, wherein the VB outlet is in airflow communication with the cooling passage at a location downstream of the heat exchanger.

The gas turbine engine of any preceding clause, wherein the gas turbine engine defines a circumferential direction, and wherein the heat exchanger is a first heat exchanger of a plurality of heat exchangers arranged along the circumferential direction within the annular cooling passage.

A method of operating a gas turbine engine comprising a fan assembly and a turbomachine drivingly coupled to a fan of the fan assembly, the method comprising: receiving data indicative of an operating condition of the gas turbine engine; and varying an amount of variable bleed airflow through a variable bleed duct provided to an annular cooling passage in response to the received data, the annular cooling passage extending between a CP inlet in airflow communication with a working gas flowpath of the turbomachine and a CP outlet in airflow communication with a bypass passage of the gas turbine engine.

The method of any preceding clause, wherein the operating condition is a low fan power operating condition, and wherein varying the amount of variable bleed airflow through the variable bleed duct provided to the annular cooling passage comprises increasing the amount of variable bleed airflow through the variable bleed duct provided to the annular cooling passage.

The method of any preceding clause, wherein the low fan power operating condition is a ground idle operating condition or a flight idle descent operating condition.

The method of any preceding clause, wherein the operating condition is indicative of an ambient temperature.

The method of any preceding clause, wherein the operating condition is indicative of the ambient temperature being greater than a threshold, and wherein varying the amount of variable bleed airflow through the variable bleed duct provided to the annular cooling passage comprises increasing the amount of variable bleed airflow through the variable bleed duct provided to the annular cooling passage.

The method of any preceding clause, wherein the variable bleed assembly comprises a variable bleed valve for varying an amount of airflow through the variable bleed duct.

The method of any preceding clause, wherein the turbomachine comprises a heat exchanger in thermal communication with an airflow through the cooling passage.

The method of any preceding clause, wherein the VB outlet is in airflow communication with the cooling passage at a location downstream of the heat exchanger.

A gas turbine engine comprising: a turbomachine, the gas turbine engine defining a bypass passage over the turbomachine, the turbomachine comprising: a compressor section having a first compressor and a second compressor and defining in part a working gas flowpath; and a compressor mid-frame extending through the working gas flowpath at a location between the first and second compressors, the compressor mid-frame comprising a forward member and an aft member; and a thrust reverser assembly comprising an inner thrust reverser support, the inner thrust reverser support comprising a forward interface coupled to the forward member of the compressor mid-frame.

The gas turbine engine of any preceding clause, wherein the inner thrust reverser support is annular and extends 360° around the turbomachine.

The gas turbine engine of any preceding clause, wherein the inner thrust reverser support is a two piece assembly.

The gas turbine engine of any preceding clause, wherein the forward interface comprises a radial member extending inwardly along the radial direction, wherein the forward member defines a circumferential groove, and wherein the radial member of the forward interface is positioned within the circumferential groove to couple the inner thrust reverser support to the compressor mid-frame.

The gas turbine engine of any preceding clause, wherein the gas turbine engine defines a circumferential direction, and wherein the inner thrust reverser support comprises a plurality of thrust reverser link attachments arranged along the circumferential direction of the gas turbine engine.

The gas turbine engine of any preceding clause, further comprising: a fan assembly comprising a fan, wherein the turbomachine is drivingly coupled to the fan; and an outer nacelle surrounding the fan and at least a portion of the turbomachine, wherein the bypass passage is defined between the turbomachine and the outer nacelle; wherein the thrust reverser assembly further comprises a cascade assembly having a plurality of drag links, wherein the drag links are attachable to the plurality of thrust reverser link attachments of the inner thrust reverser support.

The gas turbine engine of any preceding clause, wherein the turbomachine further comprises a variable bleed assembly comprising a variable bleed duct extending between a VB inlet and a VB outlet, the VB inlet in airflow communication with the working gas flowpath at a location aligned with the compressor mid-frame.

The gas turbine engine of any preceding clause, wherein the VB outlet is in airflow communication with the bypass passage at a location aft of the forward member of the compressor mid-frame.

The gas turbine engine of any preceding clause, wherein the VB outlet is in airflow communication with the bypass passage at a location forward of the aft member of the compressor mid-frame.

The gas turbine engine of any preceding clause, wherein the thrust reverser assembly comprises a seal positioned between the compressor mid-frame and the inner thrust reverser support.

The gas turbine engine of any preceding clause, wherein the VB outlet is in airflow communication with the bypass passage at a location forward of the forward interface of the thrust reverser support.

The gas turbine engine of any preceding clause, wherein the turbomachine further comprises a variable bleed assembly comprising a variable bleed duct, wherein the variable bleed duct of the variable bleed assembly extends forward of the forward member of the compressor mid-frame.

A gas turbine engine comprising: a turbomachine, the gas turbine engine defining a bypass passage over the turbomachine, the turbomachine comprising: a compressor section having a first compressor and a second compressor and defining in part a working gas flowpath; a compressor mid-frame extending through the working gas flowpath at a location between the first and second compressors, the compressor mid-frame comprising a forward member and an aft member; and a variable bleed assembly comprising a variable bleed duct extending between a VB inlet and an VB outlet, the VB inlet in airflow communication with the working gas flowpath at a location aligned with the compressor mid-frame, wherein the VB outlet is in airflow communication with the bypass passage at a location forward of the forward member of the compressor mid-frame, the variable bleed duct of the variable bleed assembly extending forward of the forward member of the compressor mid-frame to the VB outlet.

The gas turbine engine of any preceding clause, further comprising: a thrust reverser assembly comprising an inner thrust reverser support, the inner thrust reverser support comprising a forward interface coupled to the forward member of the compressor mid-frame.

The gas turbine engine of any preceding clause, wherein the VB outlet is in airflow communication with the bypass passage at a location forward of the forward interface of the inner thrust reverser support.

The gas turbine engine of any preceding clause, wherein the forward interface comprises a radial member extending inwardly along a radial direction of the gas turbine engine, wherein the forward member defines a circumferential groove, and wherein the radial member of the forward interface is positioned within the circumferential groove to couple the inner thrust reverser support to the compressor mid-frame.

The gas turbine engine of any preceding clause, wherein the gas turbine engine defines a circumferential direction, and wherein the inner thrust reverser support comprises a plurality of thrust reverser link attachments arranged along the circumferential direction of the gas turbine engine.

The gas turbine engine of any preceding clause, wherein the VB outlet is in airflow communication with the bypass passage at a location aft of the forward member of the compressor mid-frame.

The gas turbine engine of any preceding clause, wherein the VB outlet is in airflow communication with the bypass passage at a location forward of the aft member of the compressor mid-frame.

The gas turbine engine of any preceding clause, further comprising: a thrust reverser assembly comprising an inner thrust reverser support, the inner thrust reverser support comprising a forward interface coupled to the forward member of the compressor mid-frame, and wherein the thrust reverser assembly comprises an aerodynamic seal positioned between the compressor mid-frame and the inner thrust reverser support.

A gas turbine engine comprising: a turbomachine, the gas turbine engine defining a bypass passage over the turbomachine, the turbomachine comprising: a compressor section having a first compressor and a second compressor and defining in part a working gas flowpath; and a compressor mid-frame extending through the working gas flowpath at a location between the first and second compressors, the compressor mid-frame comprising a forward member and an aft member; and a hinged cowl assembly extending at least partially around the compressor section of the turbomachine, the hinged cowl assembly comprising a forward interface coupled to the forward member of the compressor mid-frame.

The gas turbine engine of any preceding clause, wherein hinged cowl assembly comprises a first member and a second member, wherein first member and the second member together extend substantially 360° when coupled together.

The gas turbine engine of any preceding clause, wherein the first member and the second member together define a hinged connection and a releasable mechanically connection.

The gas turbine engine of any preceding clause, wherein the hinged cowl assembly is an inner thrust reverser support of a thrust reverser assembly of the gas turbine engine.

The gas turbine engine of any preceding clause, wherein the forward interface comprises a radial member extending inwardly along the radial direction, wherein the forward member defines a circumferential groove, and wherein the radial member of the forward interface is positioned within the circumferential groove to couple the hinged cowl assembly to the compressor mid-frame.

A gas turbine engine comprising: a fan assembly comprising a fan; and a turbomachine drivingly coupled to the fan and comprising a compressor section, a combustion section, and a turbine section arranged in serial flow order and defining in part a working gas flowpath, the gas turbine engine defining a bypass passage over the turbomachine; the turbomachine further comprising a heat exchanger and defining an annular cooling passage extending between an inlet and an outlet, the inlet in airflow communication with the working gas flowpath at a location upstream of the compressor section and the outlet in airflow communication with the bypass passage, the heat exchanger in thermal communication with an airflow through the cooling passage.

The gas turbine engine of any preceding clause, wherein the compressor section comprises a low pressure compressor and a high pressure compressor, and wherein the inlet is in airflow communication with the working gas flowpath at a location upstream of the low pressure compressor.

The gas turbine engine of any preceding clause, wherein the low pressure compressor is located downstream of the fan and is wherein no intermediate stages of compression are located between the fan and the low pressure compressor.

The gas turbine engine of any preceding clause, wherein the fan is a single stage fan.

The gas turbine engine of any preceding clause, further comprising: an outer nacelle surrounding the fan and at least a portion of the turbomachine, wherein the bypass passage is defined between the turbomachine and the outer nacelle.

The gas turbine engine of any preceding clause, wherein the turbomachine defines a turbomachine inlet to the working gas flowpath, wherein the turbomachine inlet is located immediately downstream of the fan, and wherein the fan is a single stage fan.

The gas turbine engine of any preceding clause, wherein the gas turbine engine defines an axial direction, and wherein the outlet is aligned with the compressor section along the axial direction.

The gas turbine engine of any preceding clause, wherein the gas turbine engine defines a circumferential direction, and wherein the heat exchanger is a first heat exchanger of a plurality of heat exchangers arranged along the circumferential direction within the annular cooling passage.

The gas turbine engine of any preceding clause, wherein the turbomachine comprises a compressor mid-frame, and wherein the outlet is in airflow communication with the bypass passage at a location forward of the compressor mid-frame.

The gas turbine engine of any preceding clause, wherein the gas turbine engine defines an axial direction, wherein the turbomachine comprises a compressor forward frame, and wherein the inlet is aligned with the compressor forward frame along the axial direction.

The gas turbine engine of any preceding clause, wherein the turbomachine includes a means for urging the airflow through the cooling passage.

The gas turbine engine of any preceding clause, wherein the turbomachine comprises an inlet scoop extending into the working gas flowpath to divert an airflow through the working gas flowpath and into the inlet of the cooling passage.

The gas turbine engine of any preceding clause, wherein the turbomachine comprises a hood extending over the outlet of the cooling passage, wherein the hood extends into the bypass passage to reduce a static pressure at the outlet of the cooling passage.

The gas turbine engine of any preceding clause, wherein the turbomachine comprises an ejector positioned in airflow communication with the cooling passage, wherein the ejector is in airflow communication with a high pressure air source.

The gas turbine engine of any preceding clause, wherein the turbomachine comprises a variable bleed assembly, and wherein the high pressure air source is the variable bleed assembly.

The gas turbine engine of any preceding clause, wherein during operating of the gas turbine engine at a first operating condition, the cooling passage is configured to receive between 2% and 20% of a total airflow through the working gas flowpath at a location upstream of the inlet.

The gas turbine engine of any preceding clause, wherein the first operating condition is a takeoff operating condition.

The gas turbine engine of any preceding clause, wherein during operating of the gas turbine engine at a first operating condition, the cooling passage is configured to receive between 4% and 12% of a total airflow through the working gas flowpath at a location upstream of the inlet.

The gas turbine engine of any preceding clause, wherein the gas turbine engine is a ducted turbofan engine.

The gas turbine engine of any preceding clause, further comprising: a reduction gearbox, wherein the turbomachine is drivingly coupled to the fan through the reduction gearbox.

A gas turbine engine comprising: a fan assembly comprising a fan; a turbomachine drivingly coupled to the fan and comprising a compressor section, a combustion section, and a turbine section arranged in serial flow order and defining in part a working gas flowpath, the gas turbine engine defining a bypass passage over the turbomachine, the turbomachine defining an annular cooling passage extending between a CP inlet and a CP outlet, the CP inlet in airflow communication with the working gas flowpath and the CP outlet in airflow communication with the bypass passage; and a variable bleed assembly comprising a variable bleed duct extending between a VB inlet and a VB outlet, the VB inlet in airflow communication with the working gas flowpath at a location downstream of the CP inlet and the VB outlet in airflow communication with the annular cooling passage for urging an airflow through the cooling passage.

The gas turbine engine of any preceding clause, wherein the compressor section comprises a compressor, wherein the CP inlet is in airflow communication with the working gas flowpath at a location upstream of the compressor, and wherein the VB inlet is in airflow communication with the working gas flowpath at a location downstream of the compressor.

The gas turbine engine of any preceding clause, wherein the compressor is a low pressure compressor.

The gas turbine engine of any preceding clause, wherein the compressor section further comprises a high pressure compressor, wherein the VB inlet is in airflow communication with the working gas flowpath at a location upstream of the high pressure compressor.

The gas turbine engine of any preceding clause, wherein the variable bleed assembly comprises a variable bleed valve for varying an amount of airflow through the variable bleed duct.

The gas turbine engine of any preceding clause, further comprising: a controller operably coupled to the variable bleed valve, wherein the controller is configured to actuate the variable bleed assembly to increase the amount of airflow through the variable bleed duct in response to an operating condition of the gas turbine engine to increase an amount of airflow through the annular cooling passage.

The gas turbine engine of any preceding clause, wherein the VB outlet forms at least in part an ejector.

The gas turbine engine of any preceding clause, wherein substantially all of an airflow through the variable bleed duct is provided through the VB outlet to the cooling passage.

The gas turbine engine of any preceding clause, wherein the VB outlet is a first VB outlet, and wherein the variable bleed duct further comprises a second VB outlet, wherein the second VB outlet is in direct airflow communication with the bypass passage.

The gas turbine engine of any preceding clause, wherein the turbomachine comprises a heat exchanger in thermal communication with the airflow through the cooling passage.

The gas turbine engine of any preceding clause, wherein the VB outlet is in airflow communication with the cooling passage at a location downstream of the heat exchanger.

The gas turbine engine of any preceding clause, wherein the gas turbine engine defines a circumferential direction, and wherein the heat exchanger is a first heat exchanger of a plurality of heat exchangers arranged along the circumferential direction within the annular cooling passage.

A method of operating a gas turbine engine comprising a fan assembly and a turbomachine drivingly coupled to a fan of the fan assembly, the method comprising: receiving data indicative of an operating condition of the gas turbine engine; and varying an amount of variable bleed airflow through a variable bleed duct provided to an annular cooling passage in response to the received data, the annular cooling passage extending between a CP inlet in airflow communication with a working gas flowpath of the turbomachine and a CP outlet in airflow communication with a bypass passage of the gas turbine engine.

The method of any preceding clause, wherein the operating condition is a low fan power operating condition, and wherein varying the amount of variable bleed airflow through the variable bleed duct provided to the annular cooling passage comprises increasing the amount of variable bleed airflow through the variable bleed duct provided to the annular cooling passage.

The method of any preceding clause, wherein the low fan power operating condition is a ground idle operating condition or a flight idle descent operating condition.

The method of any preceding clause, wherein the operating condition is indicative of an ambient temperature.

The method of any preceding clause, wherein the operating condition is indicative of the ambient temperature being greater than a threshold, and wherein varying the amount of variable bleed airflow through the variable bleed duct provided to the annular cooling passage comprises increasing the amount of variable bleed airflow through the variable bleed duct provided to the annular cooling passage.

The method of any preceding clause, wherein the variable bleed assembly comprises a variable bleed valve for varying an amount of airflow through the variable bleed duct.

The method of any preceding clause, wherein the turbomachine comprises a heat exchanger in thermal communication with an airflow through the cooling passage.

The method of any preceding clause, wherein the VB outlet is in airflow communication with the cooling passage at a location downstream of the heat exchanger.

A gas turbine engine comprising: a turbomachine, the gas turbine engine defining a bypass passage over the turbomachine, the turbomachine comprising: a compressor section having a first compressor and a second compressor and defining in part a working gas flowpath; and a compressor mid-frame extending through the working gas flowpath at a location between the first and second compressors, the compressor mid-frame comprising a forward member and an aft member; and a thrust reverser assembly comprising an inner thrust reverser support, the inner thrust reverser support comprising a forward interface coupled to the forward member of the compressor mid-frame.

The gas turbine engine of any preceding clause, wherein the inner thrust reverser support is annular and extends 360° around the turbomachine.

The gas turbine engine of any preceding clause, wherein the inner thrust reverser support is a two piece assembly.

The gas turbine engine of any preceding clause, wherein the forward interface comprises a radial member extending inwardly along the radial direction, wherein the forward member defines a circumferential groove, and wherein the radial member of the forward interface is positioned within the circumferential groove to couple the inner thrust reverser support to the compressor mid-frame.

The gas turbine engine of any preceding clause, wherein the gas turbine engine defines a circumferential direction, and wherein the inner thrust reverser support comprises a plurality of thrust reverser link attachments arranged along the circumferential direction of the gas turbine engine.

The gas turbine engine of any preceding clause, further comprising: a fan assembly comprising a fan, wherein the turbomachine is drivingly coupled to the fan; and an outer nacelle surrounding the fan and at least a portion of the turbomachine, wherein the bypass passage is defined between the turbomachine and the outer nacelle; wherein the thrust reverser assembly further comprises a cascade assembly having a plurality of drag links, wherein the drag links are attachable to the plurality of thrust reverser link attachments of the inner thrust reverser support.

The gas turbine engine of any preceding clause, wherein the turbomachine further comprises a variable bleed assembly comprising a variable bleed duct extending between a VB inlet and a VB outlet, the VB inlet in airflow communication with the working gas flowpath at a location aligned with the compressor mid-frame.

The gas turbine engine of any preceding clause, wherein the VB outlet is in airflow communication with the bypass passage at a location aft of the forward member of the compressor mid-frame.

The gas turbine engine of any preceding clause, wherein the VB outlet is in airflow communication with the bypass passage at a location forward of the aft member of the compressor mid-frame.

The gas turbine engine of any preceding clause, wherein the thrust reverser assembly comprises a seal positioned between the compressor mid-frame and the inner thrust reverser support.

The gas turbine engine of any preceding clause, wherein the VB outlet is in airflow communication with the bypass passage at a location forward of the forward interface of the thrust reverser support.

The gas turbine engine of any preceding clause, wherein the turbomachine further comprises a variable bleed assembly comprising a variable bleed duct, wherein the variable bleed duct of the variable bleed assembly extends forward of the forward member of the compressor mid-frame.

A gas turbine engine comprising: a turbomachine, the gas turbine engine defining a bypass passage over the turbomachine, the turbomachine comprising: a compressor section having a first compressor and a second compressor and defining in part a working gas flowpath; a compressor mid-frame extending through the working gas flowpath at a location between the first and second compressors, the compressor mid-frame comprising a forward member and an aft member; and a variable bleed assembly comprising a variable bleed duct extending between a VB inlet and an VB outlet, the VB inlet in airflow communication with the working gas flowpath at a location aligned with the compressor mid-frame, wherein the VB outlet is in airflow communication with the bypass passage at a location forward of the forward member of the compressor mid-frame, the variable bleed duct of the variable bleed assembly extending forward of the forward member of the compressor mid-frame to the VB outlet.

The gas turbine engine of any preceding clause, further comprising: a thrust reverser assembly comprising an inner thrust reverser support, the inner thrust reverser support comprising a forward interface coupled to the forward member of the compressor mid-frame.

The gas turbine engine of any preceding clause, wherein the VB outlet is in airflow communication with the bypass passage at a location forward of the forward interface of the inner thrust reverser support.

The gas turbine engine of any preceding clause, wherein the forward interface comprises a radial member extending inwardly along a radial direction of the gas turbine engine, wherein the forward member defines a circumferential groove, and wherein the radial member of the forward interface is positioned within the circumferential groove to couple the inner thrust reverser support to the compressor mid-frame.

The gas turbine engine of any preceding clause, wherein the gas turbine engine defines a circumferential direction, and wherein the inner thrust reverser support comprises a plurality of thrust reverser link attachments arranged along the circumferential direction of the gas turbine engine.

The gas turbine engine of any preceding clause, wherein the VB outlet is in airflow communication with the bypass passage at a location aft of the forward member of the compressor mid-frame.

The gas turbine engine of any preceding clause, wherein the VB outlet is in airflow communication with the bypass passage at a location forward of the aft member of the compressor mid-frame.

The gas turbine engine of any preceding clause, further comprising: a thrust reverser assembly comprising an inner thrust reverser support, the inner thrust reverser support comprising a forward interface coupled to the forward member of the compressor mid-frame, and wherein the thrust reverser assembly comprises an aerodynamic seal positioned between the compressor mid-frame and the inner thrust reverser support.

A gas turbine engine comprising: a turbomachine, the gas turbine engine defining a bypass passage over the turbomachine, the turbomachine comprising: a compressor section having a first compressor and a second compressor and defining in part a working gas flowpath; and a compressor mid-frame extending through the working gas flowpath at a location between the first and second compressors, the compressor mid-frame comprising a forward member and an aft member; and a hinged cowl assembly extending at least partially around the compressor section of the turbomachine, the hinged cowl assembly comprising a forward interface coupled to the forward member of the compressor mid-frame.

The gas turbine engine of any preceding clause, wherein hinged cowl assembly comprises a first member and a second member, wherein first member and the second member together extend substantially 360° when coupled together.

The gas turbine engine of any preceding clause, wherein the first member and the second member together define a hinged connection and a releasable mechanically connection.

The gas turbine engine of any preceding clause, wherein the hinged cowl assembly is an inner thrust reverser support of a thrust reverser assembly of the gas turbine engine.

The gas turbine engine of any preceding clause, wherein the forward interface comprises a radial member extending inwardly along the radial direction, wherein the forward member defines a circumferential groove, and wherein the radial member of the forward interface is positioned within the circumferential groove to couple the hinged cowl assembly to the compressor mid-frame.

A gas turbine engine for an aircraft comprising: an annular casing; a fan disposed inside the annular casing and mounted for rotation about an axial centerline, the fan including fan blades that extend radially outwardly toward the annular casing; and a core turbine engine drivingly coupled to the fan and comprising a compressor section, a combustion section, and a turbine section arranged in serial flow order and defining in part a working gas flowpath, the gas turbine engine defining a bypass passage over the core turbine engine, the core turbine engine defining an annular cooling passage extending between a CP inlet and a CP outlet, the CP inlet in airflow communication with the working gas flowpath and the CP outlet in airflow communication with the bypass passage; wherein the fan includes an average fan chord width of the fan blades (“c”), a diameter of the fan (“D”), a fan pressure ratio (“FPR”), and a redline corrected fan tip Mach number (“M_{tip,c}^{(RL)}”, according to a First Performance Factor (“FPF”), wherein

$$F P F = [ \frac{c}{0.15 \cdot D} ] / [ [ \frac{\sqrt{F P R - 1}}{\sqrt{0.4}} ] / {M}_{tip , c}^{( R L )} ] - 1.23 ,$$

$$wherein {m}_{1} \cdot [ {M}_{tip , c}^{( R L )} - 1.1 ] + 9.14 > F P F > {m}_{2} \cdot [ {M}_{tip , c}^{( R L )} - 1.1 ] ,$$

and wherein m₁ is equal to 9.43 when M_{tip,c}^{(RL)} is greater than or equal to 1.1 and is equal to 27.02 when M_{tip,c}^{(RL)} is less than 1.1, and wherein m₂ is equal to 0.87 when M_{tip,c}^{(RL)} is greater than or equal to 1.1 and is equal to 3.34 when M_{tip,c}^{(RL)} is less than 1.1.

The gas turbine engine of one or more of these clauses, wherein FPF is within a range equal to or greater than −0.8 and equal to or less than 8.4.

The gas turbine engine of one or more of these clauses, wherein FPF is within a range equal to or greater than 0 and equal to or less than 6.

The gas turbine engine of one or more of these clauses, wherein FPF is within a range equal to or greater than 1 and equal to or less than 2.

The gas turbine engine of one or more of these clauses, wherein M_{tip,c}^{(RL)} is within a range equal to or greater than 0.8 and equal to or less than 1.5.

The gas turbine engine of one or more of these clauses, wherein M_{tip,c}^{(RL)} is within a range equal to or greater than 0.9 and equal to or less than 1.4.

The gas turbine engine of one or more of these clauses, wherein ratio c/D is within a range equal to or greater than 0.1 and equal to or less than 0.3.

The gas turbine engine of one or more of these clauses, wherein FPR is within a range equal to or greater than 1.2 and equal to or less than 1.6.

The gas turbine engine of one or more of these clauses, wherein FPR is within a range equal to or greater than 1.3 and equal to or less than 1.5.

The gas turbine engine of one or more of these clauses, wherein FPR is within a range equal to or greater than 1.35 and equal to or less than 1.45.

The gas turbine engine of one or more of these clauses, wherein the turbomachine has a gear ratio within a range equal to or greater than 3.2 and equal to or less than 5.0.

The gas turbine engine of one or more of these clauses, wherein the fan blade includes an airfoil portion made from a polymer matrix composite (PMC) material, a metallic leading edge, the ratio c/D is between 0.16 and 0.21, and the fan has between 16 and 25 fan blades.

The gas turbine engine of one or more of these clauses, further comprising a variable bleed assembly comprising a variable bleed duct extending between a VB inlet and a VB outlet, the VB inlet in airflow communication with the working gas flowpath at a location downstream of the CP inlet and the VB outlet in airflow communication with the annular cooling passage for urging an airflow through the cooling passage.

The gas turbine engine of one or more of these clauses, wherein the compressor section comprises a compressor, wherein the CP inlet is in airflow communication with the working gas flowpath at a location upstream of the compressor, and wherein the VB inlet is in airflow communication with the working gas flowpath at a location downstream of the compressor.

The turbomachine of one or more of these clauses, wherein the compressor is a low pressure compressor.

The gas turbine engine of one or more of these clauses, wherein the compressor section further comprises a high pressure compressor, wherein the VB inlet is in airflow communication with the working gas flowpath at a location upstream of the high pressure compressor.

The gas turbine engine of one or more of these clauses, wherein the variable bleed assembly comprises a variable bleed valve for varying an amount of airflow through the variable bleed duct.

The gas turbine engine of one or more of these clauses, further comprising: a controller operably coupled to the variable bleed valve, wherein the controller is configured to actuate the variable bleed assembly to increase the amount of airflow through the variable bleed duct in response to an operating condition of the gas turbine engine to increase an amount of airflow through the annular cooling passage.

The gas turbine engine of one or more of these clauses, wherein the VB outlet forms at least in part an ejector.

The gas turbine engine of one or more of these clauses, wherein substantially all of an airflow through the variable bleed duct is provided through the VB outlet to the cooling passage.

The gas turbine engine of one or more of these clauses, wherein the VB outlet is a first VB outlet, and wherein the variable bleed duct further comprises a second VB outlet, wherein the second VB outlet is in direct airflow communication with the bypass passage.

The gas turbine engine of one or more of these clauses, wherein the core turbine engine comprises a heat exchanger in thermal communication with the airflow through the cooling passage.

The gas turbine engine of one or more of these clauses, wherein the VB outlet is in airflow communication with the cooling passage at a location downstream of the heat exchanger.

The gas turbine engine of one or more of these clauses, wherein the gas turbine engine defines a circumferential direction, and wherein the heat exchanger is a first heat exchanger of a plurality of heat exchangers arranged along the circumferential direction within the annular cooling passage.

The gas turbine engine of one or more of these clauses, wherein the core turbine engine further comprises a heat exchanger and defines an annular cooling passage extending between an inlet and an outlet, the inlet in airflow communication with the working gas flowpath at a location upstream of the compressor section and the outlet in airflow communication with the bypass passage, the heat exchanger in thermal communication with an airflow through the cooling passage.

The gas turbine engine of one or more of these clauses, wherein the compressor section comprises a low pressure compressor and a high pressure compressor, and wherein the inlet is in airflow communication with the working gas flowpath at a location upstream of the low pressure compressor.

The gas turbine engine of one or more of these clauses, wherein the low pressure compressor is located downstream of the fan and wherein no intermediate stages of compression are located between the fan and the low pressure compressor.

A gas turbine engine comprising: an annular casing; a fan disposed inside the annular casing and mounted for rotation about an axial centerline, the fan including fan blades that extend radially outwardly toward the annular casing; and a core turbine engine drivingly coupled to the fan and comprising a compressor section, a combustion section, and a turbine section arranged in serial flow order and defining in part a working gas flowpath, the gas turbine engine defining a bypass passage over the core turbine engine, the core turbine engine defining an annular cooling passage extending between a CP inlet and a CP outlet, the CP inlet in airflow communication with the working gas flowpath and the CP outlet in airflow communication with the bypass passage; wherein the fan includes a fan hub-to-tip ratio (“HTR”), a fan blade count (“BC”), a fan pressure ratio (“FPR”), and a redline corrected fan tip Mach number (“M_{tip,c}^{(RL)}”) according to a Second Performance Factor (“SPF”), wherein

$$S P F = \frac{\sqrt{\frac{π}{4} ( 1 - H T {R}^{2} ) / ( \frac{B C}{20} )}}{( \frac{\sqrt{F P R - 1}}{\sqrt{0.4}} ) / {M}_{tip , c}^{( R L )}} - 0.97 ,$$

$$wherein {m}_{3} \cdot [ {M}_{tip , c}^{( R L )} - 1.1 ] + 2.52 > S P F > {m}_{4} \cdot [ {M}_{tip , c}^{( R L )} - 1.1 ]$$

wherein m₃ is equal to 3.17, and wherein m₄ is equal to 0.41 when M_{tip,c}^{(RL)} is greater than or equal to 1.1 and is equal to 0.55 when M_{tip,c}^{(RL)} is less than 1.1.

The gas turbine engine of one or more of these clauses, wherein SPF is within a range equal to or greater than 0.087 and equal to or less than 2.4.

The gas turbine engine of one or more of these clauses, wherein SPF is within a range equal to or greater than 1 and equal to or less than 2.

The gas turbine engine of one or more of these clauses, wherein M_{tip,c}^{(RL)} is within a range equal to or greater than 0.8 and equal to or less than 1.5.

The gas turbine engine of one or more of these clauses, wherein M_{tip,c}^{(RL)} is within a range equal to or greater than 0.9 and equal to or less than 1.4.

The gas turbine engine of one or more of these clauses, wherein HTR is within a range equal to or greater than 0.2 and equal to or less than 0.4.

The gas turbine engine of one or more of these clauses, wherein HTR is within a range equal to or greater than 0.25 and equal to or less than 0.35.

The gas turbine engine of one or more of these clauses, wherein FPR is within a range equal to or greater than 1.2 and equal to or less than 1.6.

The gas turbine engine of one or more of these clauses, wherein FPR is within a range equal to or greater than 1.3 and equal to or less than 1.5.

The gas turbine engine of one or more of these clauses, wherein FPR is within a range equal to or greater than 1.35 and equal to or less than 1.45.

The gas turbine engine of one or more of these clauses, wherein BC is within a range equal to or greater than 3 and equal to or less than 18.

The gas turbine engine of one or more of these clauses, wherein BC is within a range equal to or greater than 10 and equal to or less than 16.

The gas turbine engine of one or more of these clauses, wherein the turbomachine has a gear ratio within a range equal to or greater than 3.2 and equal to or less than 5.0.

The gas turbine engine of one or more of these clauses, wherein the fan blade includes an airfoil portion made from a polymer matrix composite (PMC) material, a metallic leading edge, the ratio c/D is between 0.16 and 0.21, and the fan has between 16 and 25 fan blades.

The gas turbine engine of one or more of these clauses, further comprising a variable bleed assembly comprising a variable bleed duct extending between a VB inlet and a VB outlet, the VB inlet in airflow communication with the working gas flowpath at a location downstream of the CP inlet and the VB outlet in airflow communication with the annular cooling passage for urging an airflow through the cooling passage.

A gas turbine engine for an aircraft comprising: an annular casing; a fan disposed inside the annular casing and mounted for rotation about an axial centerline, the fan including fan blades that extend radially outwardly toward the annular casing; and a core turbine engine drivingly coupled to the fan and comprising a compressor section, a combustion section, and a turbine section arranged in serial flow order and defining in part a working gas flowpath, the gas turbine engine defining a bypass passage over the core turbine engine, the core turbine engine defining an annular cooling passage extending between a CP inlet and a CP outlet, the CP inlet in airflow communication with the working gas flowpath and the CP outlet in airflow communication with the bypass passage; wherein the fan includes an average fan chord width of the fan blades (“c”), a diameter of the fan (“D”), a fan pressure ratio (“FPR”), and a redline corrected fan tip Mach number (“M_{tip,c}^{(RL)}”, according to a First Performance Factor (“FPF”), wherein

$$F P F = [ \frac{c}{0.15 \cdot D} ] / [ [ \frac{\sqrt{F P R - 1}}{\sqrt{0.4}} ] / {M}_{tip , c}^{( R L )} ] - 1.23 ,$$

$$wherein {m}_{1} \cdot [ {M}_{tip , c}^{( R L )} - 1.1 ] + 9.14 > F P F > {m}_{2} \cdot [ {M}_{tip , c}^{( R L )} - 1.1 ] ,$$

and wherein m₁ is equal to 9.43 when M_{tip,c}^{(RL)} is greater than or equal to 1.1 and is equal to 27.02 when M_{tip,c}^{(RL)} is less than 1.1, and wherein m₂ is equal to 0.87 when M_{tip,c}^{(RL)} is greater than or equal to 1.1 and is equal to 3.34 when M_{tip,c}^{(RL)} is less than 1.1; wherein the fan includes a fan hub-to-tip ratio (“HTR”), a fan blade count (“BC”), the fan pressure ratio (“FPR”), and the redline corrected fan tip Mach number (“M_{tip,c}^{(RL)}”) according to a Second Performance Factor (“SPF”), wherein

$$S P F = \frac{\sqrt{\frac{π}{4} ( 1 - H T {R}^{2} ) / ( \frac{B C}{20} )}}{( \frac{\sqrt{F P R - 1}}{\sqrt{0.4}} ) / {M}_{tip , c}^{( R L )}} - 0.97 ,$$

$$wherein {m}_{3} \cdot [ {M}_{tip , c}^{( R L )} - 1.1 ] + 2.52 > S P F > {m}_{4} \cdot [ {M}_{tip , c}^{( R L )} - 1.1 ]$$

wherein m₃ is equal to 3.17, and
wherein m₄ is equal to 0.41 when M_{tip,c}^{(RL)} is greater than or equal to 1.1 and is equal to 0.55 when M_{tip,c}^{(RL)} is less than 1.1.

The gas turbine engine of one or more of these clauses, wherein FPF is within a range equal to or greater than −0.8 and equal to or less than 8.4.

The gas turbine engine of one or more of these clauses, wherein FPF is within a range equal to or greater than 0 and equal to or less than 6.

The gas turbine engine of one or more of these clauses, wherein FPF is within a range equal to or greater than 1 and equal to or less than 2.

The gas turbine engine of one or more of these clauses, wherein SPF is within a range equal to or greater than 0.087 and equal to or less than 2.4.

The gas turbine engine of one or more of these clauses, wherein SPF is within a range equal to or greater than 1 and equal to or less than 2.

The gas turbine engine of one or more of these clauses, wherein M_{tip,c}^{(RL)} is within a range equal to or greater than 0.8 and equal to or less than 1.5.

The gas turbine engine of one or more of these clauses, wherein M_{tip,c}^{(RL)} is within a range equal to or greater than 0.9 and equal to or less than 1.4.

The gas turbine engine of one or more of these clauses, wherein ratio c/D is within a range equal to or greater than 0.1 and equal to or less than 0.3.

The gas turbine engine of one or more of these clauses, wherein HTR is within a range equal to or greater than 0.2 and equal to or less than 0.4.

The gas turbine engine of one or more of these clauses, wherein HTR is within a range equal to or greater than 0.25 and equal to or less than 0.35.

The gas turbine engine of one or more of these clauses, wherein FPR is within a range equal to or greater than 1.2 and equal to or less than 1.6.

The gas turbine engine of one or more of these clauses, wherein FPR is within a range equal to or greater than 1.3 and equal to or less than 1.5.

The gas turbine engine of one or more of these clauses, wherein FPR is within a range equal to or greater than 1.35 and equal to or less than 1.45.

The gas turbine engine of one or more of these clauses, wherein BC is within a range equal to or greater than 3 and equal to or less than 18.

The gas turbine engine of one or more of these clauses, wherein BC is within a range equal to or greater than 10 and equal to or less than 16.

The gas turbine engine of one or more of these clauses, wherein the turbomachine has a gear ratio within a range equal to or greater than 3.2 and equal to or less than 5.0.

The gas turbine engine of one or more of these clauses, wherein the fan blade includes an airfoil portion made from a polymer matrix composite (PMC) material, a metallic leading edge, the ratio c/D is between 0.16 and 0.21, and the fan has between 16 and 25 fan blades.

The gas turbine engine of one or more of these clauses, further comprising a variable bleed assembly comprising a variable bleed duct extending between a VB inlet and a VB outlet, the VB inlet in airflow communication with the working gas flowpath at a location downstream of the CP inlet and the VB outlet in airflow communication with the annular cooling passage for urging an airflow through the cooling passage.

What is claimed is:

1. A gas turbine engine for an aircraft comprising:
an annular casing;
a fan disposed inside the annular casing and mounted for rotation about an axial centerline, the fan including fan blades that extend radially outwardly toward the annular casing;
and a core turbine engine drivingly coupled to the fan and comprising a compressor section, a combustion section, and a turbine section arranged in serial flow order and defining in part a working gas flowpath, the gas turbine engine defining a bypass passage over the core turbine engine, the core turbine engine defining an annular cooling passage extending between a CP inlet and a CP outlet, the CP inlet in airflow communication with the working gas flowpath and the CP outlet in airflow communication with the bypass passage;
wherein the fan includes an average fan chord width of the fan blades (“c”), a diameter of the fan (“D”), a fan pressure ratio (“FPR”), and a redline corrected fan tip Mach number (“M_{tip,c}^{(RL)}”) according to a First Performance Factor (“FPF”), wherein
$$F P F = [ \frac{c}{0.15 \cdot D} ] / [ [ \frac{\sqrt{F P R - 1}}{\sqrt{0.4}} ] / {M}_{tip , c}^{( R L )} ] - 1.23 ,$$
$$wherein {m}_{1} \cdot [ {M}_{tip , c}^{( R L )} - 1.1 ] + 9.14 > F P F > {m}_{2} \cdot [ {M}_{tip , c}^{( R L )} - 1.1 ] ,$$
and
wherein m₁ is equal to 9.43 when M_{tip,c}^{(RL)} is greater than or equal to 1.1 and is equal to 27.02 when M_{tip,c}^{(RL)} is less than 1.1, and
wherein m₂ is equal to 0.87 when M_{tip,c}^{(RL)} is greater than or equal to 1.1 and is equal to 3.34 when M_{tip,c}^{(RL)} is less than 1.1.

2. The gas turbine engine of claim 1, wherein:
FPF is within a range equal to or greater than −0.8 and equal to or less than 8.4;
M_{tip,c}^{(RL)} is within a range equal to or greater than 0.8 and equal to or less than 1.5;
ratio c/D is within a range equal to or greater than 0.1 and equal to or less than 0.3; and
FPR is within a range equal to or greater than 1.2 and equal to or less than 1.6.

3. The gas turbine engine of claim 1, further comprising a variable bleed assembly including a variable bleed duct extending between a VB inlet and a VB outlet, the VB inlet in airflow communication with the working gas flowpath at a location downstream of the CP inlet and the VB outlet in airflow communication with the annular cooling passage for urging an airflow through the cooling passage.

4. The gas turbine engine of claim 3, wherein the compressor section comprises a compressor, wherein the CP inlet is in airflow communication with the working gas flowpath at a location upstream of the compressor, and wherein the VB inlet is in airflow communication with the working gas flowpath at a location downstream of the compressor.

5. The gas turbine engine of claim 4, wherein:
the compressor is a low pressure compressor; and
the compressor section further comprises a high pressure compressor, wherein the VB inlet is in airflow communication with the working gas flowpath at a location upstream of the high pressure compressor.

6. The gas turbine engine of claim 3, wherein:
the variable bleed assembly comprises a variable bleed valve for varying an amount of airflow through the variable bleed duct; and
the gas turbine engine further comprises a controller operably coupled to the variable bleed valve, wherein the controller is configured to actuate the variable bleed assembly to increase the amount of airflow through the variable bleed duct in response to an operating condition of the gas turbine engine to increase an amount of airflow through the annular cooling passage.

7. The gas turbine engine of claim 3, wherein substantially all of an airflow through the variable bleed duct is provided through the VB outlet to the cooling passage.

8. The gas turbine engine of claim 3, wherein the VB outlet is a first VB outlet, and wherein the variable bleed duct further comprises a second VB outlet, wherein the second VB outlet is in direct airflow communication with the bypass passage.

9. The gas turbine engine of claim 3, wherein the core turbine engine comprises a heat exchanger in thermal communication with the airflow through the cooling passage.

10. The gas turbine engine of claim 9, wherein the VB outlet is in airflow communication with the cooling passage at a location downstream of the heat exchanger.

11. The gas turbine engine of claim 9, wherein the gas turbine engine defines a circumferential direction, and wherein the heat exchanger is a first heat exchanger of a plurality of heat exchangers arranged along the circumferential direction within the annular cooling passage.

12. The gas turbine engine of claim 1, wherein the core turbine engine further comprises a heat exchanger and defines an annular cooling passage extending between an inlet and an outlet, the inlet in airflow communication with the working gas flowpath at a location upstream of the compressor section and the outlet in airflow communication with the bypass passage, the heat exchanger in thermal communication with an airflow through the cooling passage.

13. The gas turbine engine of claim 12, wherein the compressor section comprises a low pressure compressor and a high pressure compressor, and wherein the inlet is in airflow communication with the working gas flowpath at a location upstream of the low pressure compressor.

14. The gas turbine engine of claim 13, wherein the low pressure compressor is located downstream of the fan and wherein no intermediate stages of compression are located between the fan and the low pressure compressor.

15. A gas turbine engine comprising:
an annular casing;
a fan disposed inside the annular casing and mounted for rotation about an axial centerline, the fan including fan blades that extend radially outwardly toward the annular casing; and
a core turbine engine drivingly coupled to the fan and comprising a compressor section, a combustion section, and a turbine section arranged in serial flow order and defining in part a working gas flowpath, the gas turbine engine defining a bypass passage over the core turbine engine, the core turbine engine defining an annular cooling passage extending between a CP inlet and a CP outlet, the CP inlet in airflow communication with the working gas flowpath and the CP outlet in airflow communication with the bypass passage;
wherein the fan includes a fan hub-to-tip ratio (“HTR”), a fan blade count (“BC”), a fan pressure ratio (“FPR”), and a redline corrected fan tip Mach number (“M_{tip,c}^{(RL)}”)) according to a Second Performance Factor (“SPF”),
wherein
$$S P F = \frac{\sqrt{\frac{π}{4} ( 1 - H T {R}^{2} ) / ( \frac{B C}{20} )}}{( \frac{\sqrt{F P R - 1}}{\sqrt{0.4}} ) / {M}_{tip , c}^{( R L )}} - 0.97 ,$$
$$wherein {m}_{3} \cdot [ {M}_{tip , c}^{( R L )} - 1.1 ] + 2.52 > S P F > {m}_{4} \cdot [ {M}_{tip , c}^{( R L )} - 1.1 ]$$
wherein m₃ is equal to 3.17, and
wherein m₄ is equal to 0.41 when M_{tip,c}^{(RL)} is greater than or equal to 1.1 and is equal to 0.55 when M_{tip,c}^{(RL)} is less than 1.1.

16. The gas turbine engine of claim 15, wherein:
SPF is within a range equal to or greater than 0.087 and equal to or less than 2.4;
M_{tip,c}^{(RL)} is within a range equal to or greater than 0.8 and equal to or less than 1.5;
HTR is within a range equal to or greater than 0.2 and equal to or less than 0.4;
FPR is within a range equal to or greater than 1.2 and equal to or less than 1.6; and
BC is within a range equal to or greater than 3 and equal to or less than 18.

17. The gas turbine engine of claim 15, further comprising a variable bleed assembly comprising a variable bleed duct extending between a VB inlet and a VB outlet, the VB inlet in airflow communication with the working gas flowpath at a location downstream of the CP inlet and the VB outlet in airflow communication with the annular cooling passage for urging an airflow through the cooling passage.

18. A gas turbine engine for an aircraft comprising:
an annular casing;
a fan disposed inside the annular casing and mounted for rotation about an axial centerline, the fan including fan blades that extend radially outwardly toward the annular casing; and
a core turbine engine drivingly coupled to the fan and comprising a compressor section, a combustion section, and a turbine section arranged in serial flow order and defining in part a working gas flowpath, the gas turbine engine defining a bypass passage over the core turbine engine, the core turbine engine defining an annular cooling passage extending between a CP inlet and a CP outlet, the CP inlet in airflow communication with the working gas flowpath and the CP outlet in airflow communication with the bypass passage;
wherein the fan includes an average fan chord width of the fan blades (“c”), a diameter of the fan (“D”), a fan pressure ratio (“FPR”), and a redline corrected fan tip Mach number (“M_{tip,c}^{(RL)}”) according to a First Performance Factor (“FPF”),
wherein
$$F P F = [ \frac{c}{0.15 \cdot D} ] / [ [ \frac{\sqrt{F P R - 1}}{\sqrt{0.4}} ] / {M}_{tip , c}^{( R L )} ] - 1.23 ,$$
$$wherein {m}_{1} [ {M}_{tip , c}^{( R L )} - 1.1 ] + 9.14 > F P F > {m}_{2} \cdot [ {M}_{tip , c}^{( R L )} - 1.1 ] ,$$
and
wherein m₁ is equal to 9.43 when M_{tip,c}^{(RL)} is greater than or equal to 1.1 and is equal to 27.02 when M_{tip,c}^{(RL)} is less than 1.1, and
wherein m₂ is equal to 0.87 when M_{tip,c}^{(RL)} is greater than or equal to 1.1 and is equal to 3.34 when M_{tip,c}^{(RL)} is less than 1.1;
wherein the fan includes a fan hub-to-tip ratio (“HTR”), a fan blade count (“BC”), the fan pressure ratio (“FPR”), and the redline corrected fan tip Mach number (“M_{tip,c}^{(RL)}”) according to a Second Performance Factor (“SPF”),
wherein
$$S P F = \frac{\sqrt{\frac{π}{4} ( 1 - H T {R}^{2} ) / ( \frac{B C}{20} )}}{( \frac{\sqrt{F P R - 1}}{\sqrt{0.4}} ) / {M}_{tip , c}^{( R L )}} - 0.97 ,$$
$$wherein {m}_{3} \cdot [ {M}_{tip , c}^{( R L )} - 1.1 ] + 2.52 > S P F > {m}_{4} \cdot [ {M}_{tip , c}^{( R L )} - 1.1 ]$$
wherein m₃ is equal to 3.17, and
wherein m₄ is equal to 0.41 when M_{tip,c}^{(RL)} is greater than or equal to 1.1 and is equal to 0.55 when M_{tip,c}^{(RL)} is less than 1.1.

19. The gas turbine engine of claim 18, wherein:
FPF is within a range equal to or greater than-0.8 and equal to or less than 8.4;
SPF is within a range equal to or greater than 0.087 and equal to or less than 2.4;
M_{tip,c}^{(RL)} is within a range equal to or greater than 0.8 and equal to or less than 1.5;
ratio c/D is within a range equal to or greater than 0.1 and equal to or less than 0.3;
HTR is within a range equal to or greater than 0.2 and equal to or less than 0.4;
FPR is within a range equal to or greater than 1.2 and equal to or less than 1.6; and
BC is within a range equal to or greater than 3 and equal to or less than 18.

20. The gas turbine engine of claim 18, further comprising a variable bleed assembly comprising a variable bleed duct extending between a VB inlet and a VB outlet, the VB inlet in airflow communication with the working gas flowpath at a location downstream of the CP inlet and the VB outlet in airflow communication with the annular cooling passage for urging an airflow through the cooling passage.
